(19) United States
(12) Patent Application Publication
(10) Pub. No.: US 2020/0015164 A1
(43) Pub. Date: Jan. 9, 2020

(54) KEY AND PACKET NUMBER MANAGEMENT FOR WAKEUP RADIO FRAMES

(71) Applicant: QUALCOMM Incorporated, San Diego, CA (US)

(72) Inventors: Alfred Asterjadhi, San Diego, CA (US); George Cherian, San Diego, CA (US); Soo Bum Lee, San Diego, CA (US); Jouni Malinen, Tuusula (FI); Maarten Menzo Wentink, Nijmegen (NL)

(21) Appl. No.: 16/454,794

(22) Filed: Jun. 27, 2019

Related U.S. Application Data
(60) Provisional application No. 62/730,280, filed on Sep. 12, 2018.
(60) Provisional application No. 62/722,819, filed on Aug. 24, 2018.
(60) Provisional application No. 62/693,902, filed on Jul. 3, 2018.

(51) Int. Cl. H04W 52/02; H04W 12/00

(52) U.S. Cl. CPC H04W 52/0229; H04W 12/001; H04W 52/0219; H04W 52/0216

(57) ABSTRACT

Methods, systems, and devices for wireless communications are described. A station (STA) may receive a wakeup radio (WUR) frame for the STA at a WUR. The STA may identify, from a number of packet number generation schemes, a scheme that the STA is to use to construct a packet number for the WUR frame. Following the scheme identification, the STA may generate a packet number for the received WUR frame using the identified scheme and determine whether to discard the WUR frame based on the generated packet number. In some implementations, the STA may determine whether the STA is to use, for communications received from an access point (AP) to the WUR, a same key or a second key, the second key being different from a first key used by the STA to receive protected communications from the AP to a primary radio of the STA.

### CROSS REFERENCE

The present Application for Patent claims the benefit of U.S. Provisional Patent Application No. 62/693,902 by Asterjadhi, et al., entitled “Key and Packet Number Management For Wakeup Radio Frames,” filed Jul. 3, 2018, and claims the benefit of U.S. Provisional Patent Application No. 62/722,819 by Asterjadhi, et al., entitled “Key and Packet Number Management For Wakeup Radio Frames” filed Aug. 24, 2018, and claims the benefit of U.S. Provisional Patent Application No. 62/730,280 by Asterjadhi, et al, entitled “Key and Packet Number Management For Wakeup Radio Frames” filed Sep. 12, 2018, assigned to the assignee hereof, and expressly incorporated herein.

### BACKGROUND

The following relates generally to wireless communications, and more specifically to key and packet number management for wakeup radio (WUR) frames.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the AP).

A STA may be in communication with an AP and on or more other STAs within a basic service set (BSS) (e.g., WLAN) of the AP. The STA may have a primary radio used for general communications and frame exchange on the WLAN and a wakeup radio for wake-up communications. In some cases the wakeup radio may provide for communications when the primary radio is in a power saving mode, as waking the wakeup radio periodically to monitor for a paging or other control or management communications, or an indication of such messages to be sent by the AP on the primary radio, on the WLAN may be more energy efficient than waking the primary radio to monitor for such messages.

STAs may include a primary radio and a wakeup radio. STAs may communicate with an AP bi-directionally using the primary radio and the wakeup radio. For example, in a WLAN, a STA may communicate with an associated AP via downlink and uplink. The downlink (or forward link) may refer to the communication link from the AP to the STA, and the uplink (or reverse link) may refer to the communication link from the STA to the AP. In a WLAN, for example, a STA may be prone to replay attacks on the primary radio and/or the wakeup radio, which may be a valid downlink transmission that is maliciously or fraudulently repeated or delayed to the STA. A replay attack may occur as a result of another STA compromising a message exchanged from the STA (e.g., via primary radio and/or wakeup radio) to another STA or AP. In an example, if the wakeup radio becomes a victim of replay attacks, the wakeup radio may unnecessarily stay in an awake state (e.g., ON mode) indefinitely, which may exhaust the corresponding STA's battery-life and impact resources of the WLAN. As use of wireless communications systems (e.g., such as WLANs) increases, security of frame exchange between an AP and one or more STAs, power consumption, etc. may become increasingly critical.

### SUMMARY

The described techniques relate to improved methods, systems, devices, or apparatuses that support key and packet number management for wakeup radio (WUR) frames. A station (STA) may communicate with an access point (AP) and one or more other STAs using a primary radio and/or a wakeup radio. The primary radio may be used during active modes or for high-data throughput applications, while the wakeup radio may be used during low power modes or for low-throughput applications. In some cases, a STA may receive wakeup transmissions via the wakeup radio and power additional circuitry (e.g., a primary radio). In some cases, a STA may be susceptible to replay attacks on the primary radio and/or the wakeup radio. A replay attack may occur as a result of another STA compromising a message exchanged from the STA (e.g., via primary radio and/or wakeup radio) to another STA or AP. In an example, if the wakeup radio becomes a victim of replay attacks it may unnecessarily stay powered ON, in some case indefinitely, which may exhaust the corresponding STA's battery-life and impact resources for the BSS. To decrease or eliminate instances of replay attacks, the primary radio and/or the wakeup radio of the STA may be configured with a packet number generation scheme for constructing a packet number for a WUR frame, as well as key maintenance and management schemes for protecting the WUR frame, while also improving security in the BSS.

Using the packet number generation scheme, the STA may construct a packet number for a received WUR frame and determine whether to discard the WUR frame based on the constructed (e.g., generated) packet number. For example, the STA may discard the WUR frame if the WUR frame is a repeated frame, which may be determined based on the generated packet number of the WUR frame and packet numbers of previously received WUR frames. The STA may also support one or more key maintenance and management schemes. For example, the STA may determine whether the STA is to use, for communications received from the AP to a wakeup radio, a same key as or a second key (e.g., an integrity group temporal key (IGTK)) that is different from a first key (e.g., a pairwise transient key (PTK)) used by the STA to receive protected communications from the AP to the primary radio of the STA. The described key maintenance and management scheme may reduce security threats for frame exchange between the STA and the AP, as well as further aide in mitigating replay attacks.

A method of wireless communications at a STA is described. The method may include receiving a WUR frame for the STA at a WUR, identifying, from among a set of packet number generation schemes, a scheme that the STA is to use to construct a packet number for the WUR frame, generating a packet number for the received WUR frame based on the identified scheme, and determining whether to discard the WUR frame based on the generated packet number.

An apparatus for wireless communications is described. The apparatus may include a first interface, a second interface, and a wireless modem. The modem may be configured to obtain, over the first interface, a WUR frame received at a WUR of a STA and identify, from among a plurality of packet number generation schemes, a scheme to use to construct a packet number for the WUR frame. The modem may be further configured to generate a packet number for the obtained WUR frame based at least in part on the identified scheme, and determine whether to discard the WUR frame based at least in part on the generated packet number.

An apparatus for wireless communications at a STA is described. The apparatus may include a processor, memory in electronic communication with the processor, and instructions stored in the memory. The instructions may be executable by the processor to cause the apparatus to receive a WUR frame for the STA at a WUR, identify, from among a set of packet number generation schemes, a scheme that the STA is to use to construct a packet number for the WUR frame, generate a packet number for the received WUR frame based on the identified scheme, and determine whether to discard the WUR frame based on the generated packet number.

Another apparatus for wireless communications at a STA is described. The apparatus may include means for receiving a WUR frame for the STA at a WUR, identifying, from among a set of packet number generation schemes, a scheme that the STA is to use to construct a packet number for the WUR frame, generating a packet number for the received WUR frame based on the identified scheme, and determining whether to discard the WUR frame based on the generated packet number.

A non-transitory computer-readable medium storing code for wireless communications at a STA is described. The code may include instructions executable by a processor to receive a WUR frame for the STA at a WUR, identify, from among a set of packet number generation schemes, a scheme that the STA is to use to construct a packet number for the WUR frame, generate a packet number for the received WUR frame based on the identified scheme, and determine whether to discard the WUR frame based on the generated packet number.

In some examples of the method, apparatuses, and non-transitory computer-readable medium described herein, generating the packet number for the received WUR frame may include operations, features, means, or instructions for identifying a sequence number in the received WUR frame, and generating the packet number based on the identified sequence number and a base packet number. In some examples of the method, apparatuses, and non-transitory computer-readable medium described herein the base packet number may be locally stored (e.g., by the STA or the apparatus). In some examples of the method, apparatuses, and non-transitory computer-readable medium described herein, generating the packet number for the received WUR frame may include operations, features, means, or instructions for identifying a partial TSF in the received WUR frame, and generating the packet number based on the identified partial TSF and a base TSF. In some examples of the method, apparatuses, and non-transitory computer-readable medium described herein the base TSF may be locally stored (e.g., by the STA or the apparatus).

Some examples of the method, apparatuses, and non-transitory computer-readable medium described herein may further include operations, features, means, or instructions for receiving, from an AP (e.g., during association with an AP), an indication of the scheme that the STA may be to use to construct the packet number. Some examples of the method, apparatuses, and non-transitory computer-readable medium described herein may further include operations, features, means, or instructions for transmitting a request identifying one of the set of packet number generation schemes.

In some examples of the method, apparatuses, and non-transitory computer-readable medium described herein, identifying the scheme further may include operations, features, means, or instructions for receiving, in response to the transmitted request, an indication of the scheme that the STA may be to use to construct the packet number, and identifying the scheme based on the received indication. In some examples of the method, apparatuses, and non-transitory computer-readable medium described herein, identifying the scheme that the STA may be to use to construct the packet number may include operations, features, means, or instructions for identifying a mode of operation for the WUR of the STA, and identifying the scheme based on the mode of operation for the WUR.

In some examples of the method, apparatuses, and non-transitory computer-readable medium described herein, identifying the scheme that the STA may be to use to construct the packet number may include operations, features, means, or instructions for identifying a first scheme of the set of packet number generation schemes when the WUR frame may be addressed to a set of STAs or a group of STAs, and identifying a second scheme of the set of packet number generation schemes when the WUR frame may be individually addressed to the STA.

In some examples of the method, apparatuses, and non-transitory computer-readable medium described herein, identifying the scheme that the STA may be to use to construct the packet number may include operations, features, means, or instructions for identifying a frame type associated with the WUR frame, and identifying the scheme based on the WUR frame type. Some examples of the method, apparatuses, and non-transitory computer-readable medium described herein may further include operations, features, means, or instructions for receiving an indication of the scheme that the STA may be to use to construct the packet number for the WUR frame based on a signaling from an AP.

In some examples of the method, apparatuses, and non-transitory computer-readable medium described herein, the signaling includes an address field of the WUR frame indicating that the WUR frame may be broadcast, group-addressed, or individually-addressed. In some examples of the method, apparatuses, and non-transitory computer-readable medium described herein, the scheme that the STA may be to use to construct the packet number for the WUR frame may be common for all STAs associated with the AP or individual for each STA associated with the AP. In some examples of the method, apparatuses, and non-transitory computer-readable medium described herein, generating the packet number of the received WUR frame may include operations, features, means, or instructions for identifying that the scheme that the STA may be to use to construct the packet number for the WUR frame may be common for all STAs associated with the AP, and generating the packet number of the WUR frame based on a TSF of the AP.

In some examples of the method, apparatuses, and non-transitory computer-readable medium described herein, generating the packet number of the received WUR frame may include operations, features, means, or instructions for identifying that the scheme that the STA may be to use to construct the packet number for the WUR frame may be individual for each STA associated with the AP, and generating the packet number of the WUR frame based on a packet number that does not repeat for a transmitter-receiver couple. Some examples of the method, apparatuses, and non-transitory computer-readable medium described herein may further include operations, features, means, or instructions for establishing a broadcast link with an access point, and initializing a stored base packet number to a value equal to at least a portion of a local TSF timer. In some examples of the method, apparatuses, and non-transitory computer-readable medium described herein, the stored packet number may be obtained from 6 bytes of the local TSF timer, the 6 bytes of the local TSF timer being 48 bits out of 64 bits of the local TSF timer.

In some examples of the method, apparatuses, and non-transitory computer-readable medium described herein, generating the packet number for the received WUR frame may include operations, features, means, or instructions for identifying a partial TSF in the received WUR frame, identifying a clock drift offset between a local TSF timer and a TSF timer of a wireless device that transmitted the WUR frame, and generating the packet number of the WUR frame based on the identified partial TSF and the identified clock drift offset. In some examples of the method, apparatuses, and non-transitory computer-readable medium described herein, identifying the clock drift offset may include operations, features, means, or instructions for identifying a first time value for receipt of the partial TSF at the STA, identifying a second time value for a second partial TSF previously received at the STA, and determining the clock drift offset based on the identified first time value, the identified second time value, and an estimated clock drift for the local TSF timer.

In some examples of the method, apparatuses, and non-transitory computer-readable medium described herein, identifying the clock drift offset may include operations, features, means, or instructions for receiving a first TSF value from an access point in a first WUR frame, receiving a second TSF value from the access point in a second WUR frame, estimating a clock drift based on comparing the first TSF value to the local TSF timer and the second TSF value to the local TSF timer, and identifying the clock drift offset based on the estimated clock drift. Some examples of the method, apparatuses, and non-transitory computer-readable medium described herein may further include operations, features, means, or instructions for initializing a stored base packet number to a value equal to zero.

Some examples of the method, apparatuses, and non-transitory computer-readable medium described herein may further include operations, features, means, or instructions for receiving an indication that an AP associated with the STA maintains separate counters for each transmitter-receiver couple, identifying a sequence number in the received WUR frame, and generating, in response to the received indication, the packet number based on the identified sequence number and a base packet number for a transmitter-receiver couple associated with the received WUR frame. In some examples of the method, apparatuses, and non-transitory computer-readable medium described herein, the sequence number may be equal to twelve least significant bits of the packet number of the received WUR frame, and the base packet number includes at least a portion of a base packet number stored at the STA.

Some examples of the method, apparatuses, and non-transitory computer-readable medium described herein may further include operations, features, means, or instructions for receiving an indication that an AP associated with the STA maintains a common packet number for all STAs associated with the AP that may be valued for all secure WUR frames generated by the AP.

A method of wireless communications at a STA is described. The method may include determining whether the STA is to use, for communications received from an AP to a wakeup radio, a same key or a second key, the second key different from a first key used by the STA to receive protected communications from the AP to a primary radio of the STA, receiving a protected WUR frame from the AP, and decoding the protected WUR frame based on the same key or the second key.

An apparatus for wireless communications is described. The apparatus may include a first interface, a second interface, and a wireless modem. The modem may be configured to determine whether the wireless modem is to use, for communications received from an AP to a wakeup radio of a STA, a same key or a second key, the second key different from a first key used by the wireless modem for protected communications received from the AP to a primary radio of the STA, obtain, over the first interface, a protected WUR frame received from the AP, and decode the protected WUR frame based at least in part on the same key or the second key.

An apparatus for wireless communications at a STA is described. The apparatus may include a processor, memory in electronic communication with the processor, and instructions stored in the memory. The instructions may be executable by the processor to cause the apparatus to determine whether the STA is to use, for communications received from an AP to a wakeup radio, a same key or a second key, the second key different from a first key used by the STA to receive protected communications from the AP to a primary radio of the STA, receive a protected WUR frame from the AP, and decode the protected WUR frame based on the same key or the second key.

Another apparatus for wireless communications at a STA is described. The apparatus may include means for determining whether the STA is to use, for communications received from an AP to a wakeup radio, a same key or a second key, the second key different from a first key used by the STA to receive protected communications from the AP to a primary radio of the STA, receiving a protected WUR frame from the AP, and decoding the protected WUR frame based on the same key or the second key.

A non-transitory computer-readable medium storing code for wireless communications at a STA is described. The code may include instructions executable by a processor to determine whether the STA is to use, for communications received from an AP to a wakeup radio, a same key or a second key, the second key different from a first key used by the STA to receive protected communications from the AP to a primary radio of the STA, receive a protected WUR frame from the AP, and decode the protected WUR frame based on the same key or the second key.

In some examples of the method, apparatuses, and non-transitory computer-readable medium described herein, the second key may be different from the first key for the primary radio by at least one bit, the at least one bit indicating that the second key may be for the wakeup radio. Some examples of the method, apparatuses, and non-transitory computer-readable medium described herein may further include operations, features, means, or instructions for determining the second key for the STA to use based on a shared secret between the STA and the AP. Some examples of the method, apparatuses, and non-transitory computer-readable medium described herein may further include operations, features, means, or instructions for deriving the second key from the first key.

In some examples of the method, apparatuses, and non-transitory computer-readable medium described herein, determining the second key may include operations, features, means, or instructions for adding a bit to the first key to generate the second key based on identifying that the wakeup radio may be to use the second key. In some examples of the method, apparatuses, and non-transitory computer-readable medium described herein, determining the second key may include operations, features, means, or instructions for applying a function to the first key to generate the second key based on identifying that the wakeup radio may be to use the second key, the applied function known to both the AP and the STA.

Some examples of the method, apparatuses, and non-transitory computer-readable medium described herein may further include operations, features, means, or instructions for receiving, from the AP, an indication that the STA may be to use one of the same key or the second key to receive protected communications using the wakeup radio. Some examples of the method, apparatuses, and non-transitory computer-readable medium described herein may further include operations, features, means, or instructions for transmitting, to the AP, an indication of a preference to use the same key or the second key, where the determination to use the same key or the second key may be based on the preference. In some examples of the method, apparatuses, and non-transitory computer-readable medium described herein, decoding the protected WUR frame may include operations, features, means, or instructions for decoding the protected WUR frame using a group key, where the protected WUR frame may be group addressed. In some examples of the method, apparatuses, and non-transitory computer-readable medium described herein, decoding the protected WUR frame may include operations, features, means, or instructions for decoding the protected WUR frame using an individual key, where the protected WUR frame is individually addressed.

In some examples of the method, apparatuses, and non-transitory computer-readable medium described herein, the first key includes an individual key for the STA to be used for communications via the primary radio, and the second key includes an individual key for the STA to be used for communications via the wakeup radio. In some examples of the method, apparatuses, and non-transitory computer-readable medium described herein, the first key comprises a first PTK and the second key comprises a second PTK. In some examples of the method, apparatuses, and non-transitory computer-readable medium described herein, the first key comprises a group key for the STA to be used for communications via the primary radio, and the second key comprises a group key for the STA to be used for communications via the wakeup radio. In some examples of the method, apparatuses, and non-transitory computer-readable medium described herein, the first key comprises a first IGTK, and the second key comprises a second IGTK. In some examples of the method, apparatuses, and non-transitory computer-readable medium described herein, the first key includes a PTK, the same key includes the PTK, and the second key includes an IGTK key. In some examples of the method, apparatuses, and non-transitory computer-readable medium described herein, the first key includes group key for a group of STAs that includes the STA, and the second key includes an individual key for the STA.

In some examples of the method, apparatuses, and non-transitory computer-readable medium described herein, the first key includes an IGTK key, the same key includes the IGTK, and the second key includes a PTK. Some examples of the method, apparatuses, and non-transitory computer-readable medium described herein may further include operations, features, means, or instructions for receiving, in one or more messages of a four-way handshake procedure with the AP, an indication that the STA may be to use one of the same key or the second key to receive protected communications using the wakeup radio.

A method of wireless communication at an AP is described. The method may include determining, from among a set of packet number generation schemes, a scheme that a STA is to use to construct a packet number for a WUR frame, generating the WUR frame based on the determined scheme, the generated WUR frame including an indication of the determined scheme, and transmitting the generated WUR frame to the STA.

An apparatus for wireless communications is described. The apparatus may include a first interface, a second interface, and a wireless modem. The modem may be configured to determine, from among a plurality of packet number generation schemes, a scheme that a STA is to use to construct a packet number for a WUR frame, generate the WUR frame based at least in part on the determined scheme, the generated WUR frame comprising an indication of the determined scheme, and provide, over the second interface, the generated WUR frame to be transmitted to the STA.

An apparatus for wireless communication at an AP is described. The apparatus may include a processor, memory in electronic communication with the processor, and instructions stored in the memory. The instructions may be executable by the processor to cause the apparatus to determine, from among a set of packet number generation schemes, a scheme that a STA is to use to construct a packet number for a WUR frame, generate the WUR frame based on the determined scheme, the generated WUR frame including an indication of the determined scheme, and transmit the generated WUR frame to the STA.

Another apparatus for wireless communication at an AP is described. The apparatus may include means for determining, from among a set of packet number generation schemes, a scheme that a STA is to use to construct a packet number for a WUR frame, generating the WUR frame based on the determined scheme, the generated WUR frame including an indication of the determined scheme, and transmitting the generated WUR frame to the STA.

A non-transitory computer-readable medium storing code for wireless communication at an AP is described. The code may include instructions executable by a processor to determine, from among a set of packet number generation schemes, a scheme that a STA is to use to construct a packet number for a WUR frame, generate the WUR frame based on the determined scheme, the generated WUR frame including an indication of the determined scheme, and transmit the generated WUR frame to the STA.

Some examples of the method, apparatuses, and non-transitory computer-readable medium described herein may further include operations, features, means, or instructions for determining the WUR frame may be individually addressed to the STA, where the scheme may be determined based on the determination that the WUR frame may be individually addressed. In some examples of the method, apparatuses, and non-transitory computer-readable medium described herein, the WUR frame may be generated based on the determined scheme and a sequence number of the WUR frame. Some examples of the method, apparatuses, and non-transitory computer-readable medium described herein may further include operations, features, means, or instructions for determining the WUR frame may be group addressed or may be a broadcast WUR frame, where the scheme may be determined based on the determination that the WUR frame may be group addressed or the determination that the WUR frame may be the broadcast WUR frame.

In some examples of the method, apparatuses, and non-transitory computer-readable medium described herein, the WUR frame may be generated based on the determined scheme and a partial TSF of the generated WUR frame. Some examples of the method, apparatuses, and non-transitory computer-readable medium described herein may further include operations, features, means, or instructions for determining the packet number based on the determined scheme, where the WUR frame may be generated based on the determined packet number. Some examples of the method, apparatuses, and non-transitory computer-readable medium described herein may further include operations, features, means, or instructions for determining a first scheme from among the set of packet number generation schemes when the WUR frame may be to be addressed to a set of STAs or a group of STAs, and determining a second scheme from among the set of packet number generation schemes when the WUR frame may be to be individually addressed to the STA.

In some examples of the method, apparatuses, and non-transitory computer-readable medium described herein, generating the WUR frame may include operations, features, means, or instructions for identifying a sequence number based on the determined scheme, and generating the WUR frame based on the identified sequence number and a base packet number. In some examples of the method, apparatuses, and non-transitory computer-readable medium described herein, generating the WUR frame may include operations, features, means, or instructions for identifying a partial TSF based on the determined scheme, and generating the WUR frame based on the identified partial TSF and a base TSF. In some examples of the method, apparatuses, and non-transitory computer-readable medium described herein, determining the scheme for the STA may include operations, features, means, or instructions for identifying a mode of operation for a WUR of the STA, and determining the scheme that the STA may be to use to construct the packet number for the WUR frame based on the identified mode of operation for the WUR.

In some examples of the method, apparatuses, and non-transitory computer-readable medium described herein, the indication of the determined scheme includes an address field of the WUR frame indicating that the WUR frame may be broadcast, group-addressed, or individually-addressed. In some examples of the method, apparatuses, and non-transitory computer-readable medium described herein, the determined scheme that the STA may be to use to construct the packet number for the WUR frame may be common for all STAs associated with the AP or individual for each STA associated with the AP.

In some examples of the method, apparatuses, and non-transitory computer-readable medium described herein, generating the WUR frame may include operations, features, means, or instructions for identifying that the determined scheme that the STA may be to use to construct the packet number for the WUR frame may be common for all STAs associated with the AP, identifying a TSF of the AP based on the identification that the determined scheme that the STA may be to use to construct the packet number for the WUR frame may be common for all STAs associated with the AP, and generating the WUR frame based on the TSF of the AP.

In some examples of the method, apparatuses, and non-transitory computer-readable medium described herein, generating the WUR frame may include operations, features, means, or instructions for identifying that the determined scheme that the STA may be to use to construct the packet number for the WUR frame may be individual for each STA associated with the AP, and generating the WUR frame based on the packet number that does not repeat for a transmitter-receiver couple. Some examples of the method, apparatuses, and non-transitory computer-readable medium described herein may further include operations, features, means, or instructions for establishing a broadcast link with the STA, and initializing a stored base packet number to a value equal to at least a portion of a local TSF timer.

Some examples of the method, apparatuses, and non-transitory computer-readable medium described herein may further include operations, features, means, or instructions for transmitting a first TSF value to the STA in a first WUR frame, and transmitting a second TSF value to the STA in a second WUR frame. Some examples of the method, apparatuses, and non-transitory computer-readable medium described herein may further include operations, features, means, or instructions for transmitting an indication that the AP maintains separate counters for each transmitter-receiver couple, and identifying a sequence number for the WUR frame, where the WUR frame may be generated based on the identified sequence number and a base packet number for a transmitter-receiver couple associated with the WUR frame.

In some examples of the method, apparatuses, and non-transitory computer-readable medium described herein, the identified sequence number may be equal to twelve least significant bits of the packet number of the WUR frame, and the base packet number includes at least a portion of a base packet number stored at the STA. Some examples of the method, apparatuses, and non-transitory computer-readable medium described herein may further include operations, features, means, or instructions for transmitting an indication that the AP maintains a common packet number for all STAs associated with the AP that may be valued for all secure WUR frames generated by the AP.

### BRIEF DESCRIPTION OF THE DRAWINGS

FIGS. 1 and 2 illustrate examples of a wireless communications system that supports key and packet number management for wakeup radio (WUR) frames in accordance with aspects of the present disclosure.

FIG. 3 illustrates an example of a WUR message structure that supports key and packet number management for WUR frames in accordance with aspects of the present disclosure.

FIGS. 4 and 5 illustrate examples of a process flow that supports key and packet number management for WUR frames in accordance with aspects of the present disclosure.

FIGS. 6 and 7 show block diagrams of devices that support key and packet number management for WUR frames in accordance with aspects of the present disclosure.

FIG. 8 shows a block diagram of a communications manager that supports key and packet number management for WUR frames in accordance with aspects of the present disclosure.

FIG. 9 shows a diagram of a system including a device that supports key and packet number management for WUR frames in accordance with aspects of the present disclosure.

FIGS. 10 and 11 show block diagrams of devices that support key and packet number management for WUR frames in accordance with aspects of the present disclosure.

FIG. 12 shows a block diagram of a communications manager that supports key and packet number management for WUR frames in accordance with aspects of the present disclosure.

FIG. 13 shows a diagram of a system including a device that supports key and packet number management for WUR frames in accordance with aspects of the present disclosure.

FIGS. 14 through 21 show flowcharts illustrating methods that support key and packet number management for WUR frames in accordance with aspects of the present disclosure.

### DETAILED DESCRIPTION

A station (STA) may be in communication with an access point (AP) and one or more other STAs within a basic service set (BSS) (e.g., a wireless local area network (WLAN)) of the AP. The STA may have one or more primary radios used for general communications and frame exchange on the WLAN and a wakeup radio for wake-up communications. In some cases the wakeup radio may provide for communications when the primary radio is in a power saving mode, as waking the wakeup radio periodically to monitor for paging or other control or management communications, or an indication of such messages to be sent by the AP on the primary radio, on the WLAN may be more energy efficient than waking the primary radio to monitor for such messages. The primary radio and/or the wakeup radio of the STA may be configured with a plurality of packet number generation schemes for constructing a packet number for a wakeup radio (WUR) frame, as well as with key maintenance and management schemes for protecting the WUR frame to reduce or eliminate replay attacks, while also improving security in the WLAN.

For example, the STA may receive a WUR frame at the wakeup radio. Upon receiving the WUR frame, the STA may identify from a plurality of packet number generation schemes, a scheme that the STA is to use to construct a packet number for the WUR frame. Once the STA has identified the scheme, the STA may generate a packet number for the received WUR frame and determine whether to discard the WUR frame based on the generated packet number. Realization and support of the packet number generation schemes described herein may decrease instances or success rates of replay attacks (e.g., occurring at the STA).

The STA may also support key maintenance and management schemes described herein. For example, the STA may determine whether the STA is to use, for communications received from the AP to wakeup radio, a same key as or a second key (e.g., an integrity group temporal key (IGTK)) that may be different from a first key (e.g., a pairwise transient key (PTK)) used by the STA to receive protected communications from the AP to the primary radio of the STA. The STA may receive and decode the protected WUR frame based on the same key or the second key. Realization and support of the key maintenance and management schemes described herein may reduce security threats for frame exchange between the STA and the AP, as well as aide in mitigating replay attacks.

Aspects of the disclosure are initially described in the context of a wireless communications system. Aspects of the disclosure are then illustrated by and described with reference to an example WUR frame message and process flow examples. Aspects of the disclosure are further illustrated by and described with reference to apparatus diagrams, system diagrams, and flowcharts that relate to key and packet number management for WUR frames

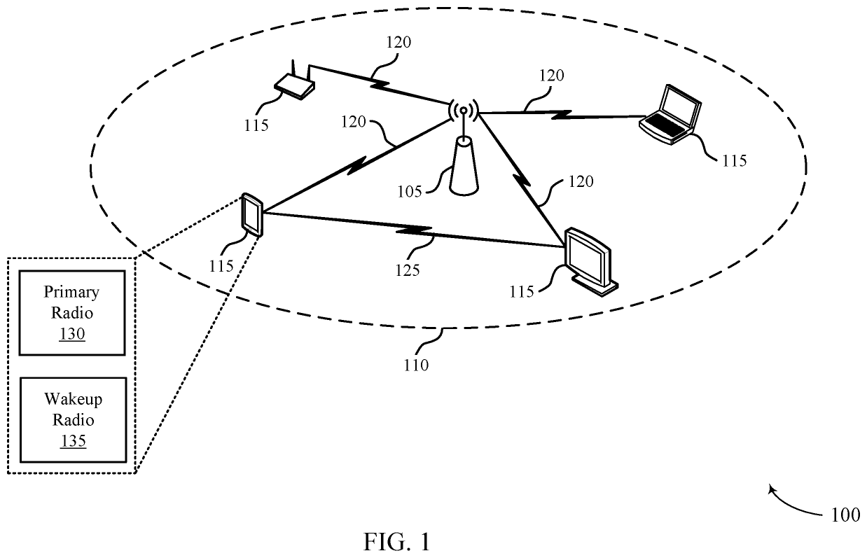

FIG. 1 illustrates an example of a WLAN 100 that supports key and packet number management for WUR frames in accordance with aspects of the present disclosure. In some examples, the WLAN 100 may be a WLAN 100 (also known as a Wi-Fi network) configured in accordance with various aspects of the present disclosure. The WLAN 100 may include an AP 105 and multiple associated STAs 115, which may represent devices such as mobile STAs, personal digital assistant (PDAs), other handheld devices, netbooks, notebook computers, tablet computers, laptops, display devices (e.g., TVs, computer monitors, etc.), printers, etc. The AP 105 and the associated STAs 115, communication via wireless links 120, may represent a BSS or an ESS. The various STAs 115 in the network are able to communicate with one another through the AP 105. Also shown is a coverage area 110 of the AP 105, which may represent a BSA of the WLAN 100. An extended network STA (not shown) associated with the WLAN 100 may be connected to a wired or wireless distribution system that may allow multiple APs 105 to be connected in an ESS.

A STA 115 may include a primary radio 130 and a wakeup radio 135. The primary radio 130 may be used during an active mode (e.g., full power modes), for high-data throughput applications, etc. The wakeup radio 135 may be used during low-power modes, for low-throughout applications, etc. In some examples, a STA 115 may listen using the wakeup radio 135 for a WUR frame. For example, the STA 115 may receive a preamble having a first frequency band (e.g., wideband, such as on a 20 MHz channel) and a wakeup signal (e.g., a WUR signal) having a second frequency band (e.g., narrowband, such as a 4-5 MHz within the 20 MHz channel). Further, the wakeup radio 135 may share a same medium (e.g., frequency spectrum targeted for reception) as the primary radio 130. However, transmissions intended for the wakeup radio 135 may be associated with lower data rates (e.g., tens or hundreds of kilobytes per second (kbps)).

A STA 115 may support packet number generation. For example, the STA 115 may receive a WUR frame at the wakeup radio 135. Upon receiving the WUR frame, the STA 115 may identify from a plurality of packet number generation schemes, a scheme that the STA 115 is to use to construct a packet number for the WUR frame. Once the STA 115 has identified the scheme it may generate a packet number for the received WUR frame and determine whether to discard the WUR frame based on the generated packet number. The STA 115 may discard the WUR frame because it may be a repeated frame, for example, as a result of an attempted replay attack.

The STA 115 may also support key maintenance and management. For example, the STA 115 may determine whether the STA 115 is to use, for communications received from AP 105 using wakeup radio 135-a, a same key as or a second key (e.g., an IGTK key) that may be different from a first key (e.g., a PTK) used by the STA 115 to receive protected communications from the AP 105 using the primary radio 130 of the STA 115. The STA 115 may receive and decode the protected WUR frame based on the same key or the second key, depending on the determination.

A STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical and medium access control (MAC) layers from IEEE 802.11 and versions including, but not limited to, 802.11b, 802.11g, 802.11a, 802.11n, 802.11ac, 802.11ad, 802.11ah, 802.11ax, 802.11ba, 802.11be, etc. In other implementations, peer-to-peer connections or ad hoc networks may be implemented within WLAN 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other. This may result in colliding transmissions for the two STAs 115 in a contention based environment (e.g., CSMA/CA) because the STAs 115 may not refrain from transmitting on top of each other. A STA 115 whose transmissions are not identifiable, but that is within the same coverage area 110 may be known as a hidden node. CSMA/CA may be supplemented by the exchange of an RTS packet transmitted by a sending STA 115 (or AP 105) and a CTS packet transmitted by the receiving STA 115 (or AP 105). This may alert other devices within range of the sender and receiver not to transmit for the duration of the primary transmission. Thus, RTS/CTS may help mitigate a hidden node problem.

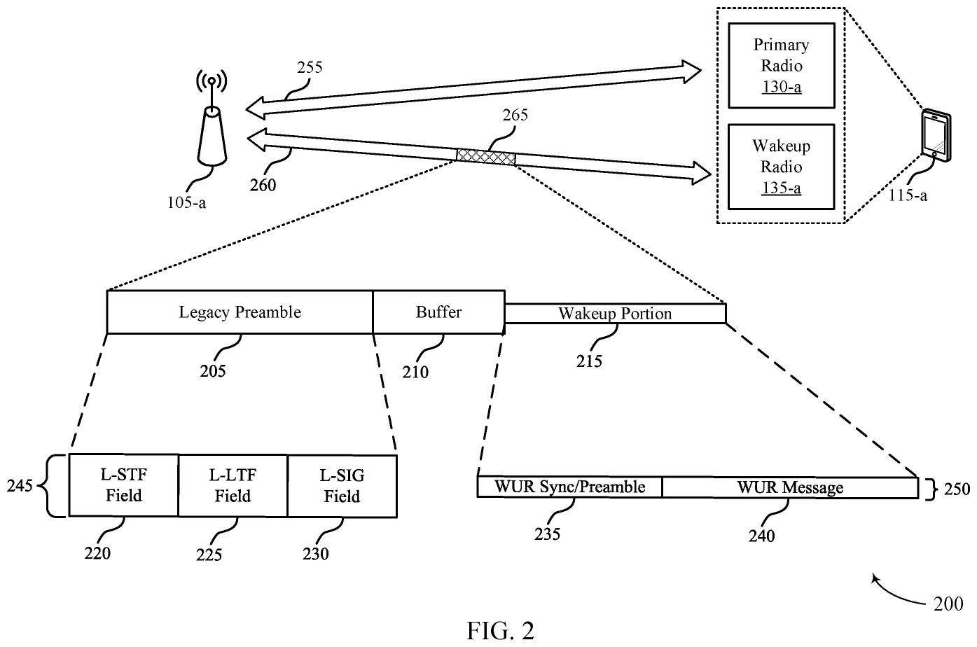

FIG. 2 illustrates an example of a WLAN 200 that supports key and packet number management for WUR frames in accordance with aspects of the present disclosure. In some examples, the WLAN 200 may implement aspects of the WLAN 100. For example, the WLAN 200 may include an AP 105-a and a STA 115-a, which may be examples of the corresponding devices described with reference to FIG. 1. The STA 115-a may include a primary radio 130-a and a wakeup radio 135-a, which may be examples of the corresponding radios described with reference to FIG. 1.

The primary radio 130-a may be used during active modes or for high-data throughput applications (e.g., for full power transmissions 255 from the AP 105-a). The wakeup radio 135-a may be used during low power modes or for low-throughput applications (e.g., for wakeup transmissions 260 from AP 105-a). In some cases, STA 115-a may receive wakeup transmissions 260 and power additional circuitry (e.g., primary radio 130-a). The wakeup radio 135-a may listen for wakeup transmissions 260 (e.g., WUR frames) and wakeup the primary radio 130-a of STA 115-a for full power transmissions 255 (e.g., high-data throughput applications).

A wakeup signal may be a physical layer conversion protocol (PLCP) protocol data unit (PPDU). In some examples, wakeup waveform 265 may include a preamble and a wakeup signal. A preamble may be transmitted over a certain bandwidth (e.g., a channel, such as a 20 MHz channel), to be understandable (e.g., monitored) by neighboring devices. However, the wakeup signal following the preamble may use a narrower bandwidth (e.g., 5 MHz or less, such as 4 MHz spanning 13 OFDM tones). If wakeup waveform 265 spans an entire, wider bandwidth of the preamble, the wakeup radio 135-a may require or consume more power than necessary for the wakeup radio 135-a to receive and decode the wakeup waveform 265. Thus, a wakeup waveform preamble may include a legacy preamble 205 and a buffer 210 transmitted on a wideband (e.g., on wider bandwidth 245), while the portion of wakeup waveform 265 that contains the wakeup message (e.g., wakeup portion 215) may be transmitted on a narrowband (e.g., narrow bandwidth 250), which may require less power to receive at the wakeup radio 135-a. Thus, power may be saved, and interference reduced.

The legacy preamble 205 may include a legacy short training field (L-STF) 220, a legacy long training field (L-LTF) field 225, and a L-SIG field 230. Upon receiving and decoding these fields, the STA 115-a may understand that the medium is to be occupied for a particular period of time (e.g., as specified by the legacy preamble 205). Other configurations of fields for the legacy preamble 205 may be used in other examples, for example, to maintain compatibility with other protocols, including future Wi-Fi protocols. The legacy preamble 205 may be transmitted on a wider bandwidth 245 than the wakeup portion 215. In some cases, the wider bandwidth 245 may be a Wi-Fi channel width (e.g., 20 MHz, 40 MHz, etc.). The wakeup portion 215 may include a WUR sync/preamble 235 and WUR message 240. In some examples, the wakeup portion 215 of the wakeup waveform 265 may be transmitted on a narrow bandwidth 250, which may require less power to receive at the wakeup radio 135-a (e.g., following reception of the legacy preamble 205, the wakeup radio 135-a may receive the wakeup portion 215 over narrow bandwidth 250 using reduced power). In some examples the narrow bandwidth 250 may be a bandwidth less than the wider bandwidth 245, for example 5 MHz or less. That is, during the wakeup portion 215, there may only be a few tones of valid information within wider bandwidth 245 (e.g., only ¼ of tones may contain valid information).

The wakeup waveform 265 comprising a WUR frame may include an indication of a packet number that may be identifiable by the STA 115-a. The packet number may be a unique number for the wakeup portion 215 (e.g., the packet number may be unique to the information of the wakeup portion 215). In some cases, the packet number may be included with a number of packets (e.g., frames) that may be transmitted serially to improve likelihood of reception at the STA 115-a. In some cases, the packet number may be an increasing (e.g., monotonically increasing) number that identifies a packet and may be used to identify replay attacks, or may be used to identify the packet for which an acknowledgment is needed. That is, the STA 115-a may use the packet number to identify multiple same WUR frames received at the STA 115-a and handle each WUR frame appropriately (e.g., the STA 115-a may discard or keep a WUR frame based on the packet number).

For example, the STA 115-a may receive the wakeup waveform 265 including a WUR frame. Following the reception of the WUR frame, the STA 115-a may identify, from a plurality of packet number generation schemes, a scheme that the STA 115-a is to use to construct a data packet number of the WUR frame. That is, the STA 115-a may be configured with a plurality of packet number generation schemes for constructing a packet number for a WUR frame, as well an integrity key for protecting the WUR frame. The STA 115-a may determine a packet number for the WUR frame based on a packet number generation scheme, and may keep or discard the WUR frame based on the packet number, based on whether a WUR frame with the same packet number was previously received, based on whether the packet number was expected or received out of order, etc.

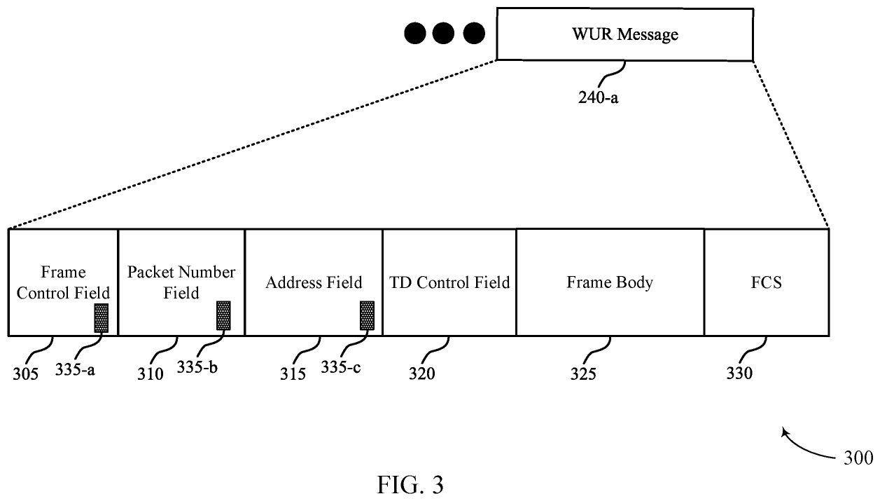

FIG. 3 illustrates an example of a WUR message structure 300 that supports key and packet number management for WUR frames in accordance with aspects of the present disclosure. For example, a WUR message 240-a (e.g., which may be based on a WUR message structure 300) may be transmitted by an AP 105 to a STA 115. The WUR message 240-a may include a frame control field 305, a packet number field 310, an address field 315, a type dependent (TD) control field 320, a frame body 325, and a frame check sequence (FCS) 330.

The frame control field 305 may identify the WUR message 240-a as a secure WUR frame. In some examples, the frame control field 305 may include 8 bits (e.g., bits B0 through B7). Additionally or alternatively, the bit size of the frame control field 305 may be determined by the AP 105 based on the capabilities of the STA 115. The size of the frame control field 305 may be signaled (e.g., via control transmissions over the primary radio 130) to the STA 115 prior to transmission of the secure WUR message 240-a. In some cases, an indication 335-a of the packet number generation scheme and/or key maintenance and management scheme may be provided in the frame control field 305.

The packet number field 310 may include a packet number for the secure WUR message 240-a. The packet number may be a unique number for the secure WUR message 240-a. In some cases, the packet number may be a partial packet number (PPN). In these cases, a synchronization process (e.g., a rollover procedure such as that which may be defined for protocol version 1 (PV1) in 802.11) may be implemented between the AP 105 and STA 115. In some cases, an indication 335-b of the packet number generation scheme and/or key maintenance and management scheme may be provided in the frame control field 305.

The address field 315 may be set to WUR ID when the WUR frame (i.e., WUR message 240-a) is individually addressed to the STA 115-a, to group identifier (ID) when the WUR frame (i.e., including WUR message 240-a) is group addressed, to transmit ID when the WUR frame (i.e., including WUR message 240-a) is broadcast addressed, and/or to 0 when multiple WUR IDs are included in the frame body 325 of WUR message 240-a. In some cases, an indication 335-c of the packet number generation scheme and/or key maintenance and management scheme may be provided in the frame control field 305. In some cases, the TD control field 320 may include a counter subfield and a reserved subfield. The counter subfield of a WUR frame (e.g., of WUR message 240-a) may be defined as an unsigned integer, initialized to 0, that increments when a critical update to BSS parameters has occurred. In some cases, as discussed in more detail herein, the TD control field 320 may include one or more of a Counter subfield, Sequence Counter subfield, and/or a Sequence Number subfield that indicates a packet number. For example, the sequence counter subfield may include PN0 (of six packet number (PN) bytes, PN0 through PN5) (e.g., in cases where the WUR message 240-a is broadcast) or PN0|PN1[0:3] (e.g., in cases where the WUR message 240-a is individually addressed). Such may be used by a receiving STA 115 for IGTK packet number (IPN) construction at the STA 115. The FCS 330 may refer to extra error-detecting code added to the WUR frame (e.g., WUR message 240-a) in a communications protocol. The FCS 330 may be 8 bits, or 16 bits in length and it may contain one or more bits of a CRC-8, CRC-16, or CRC-32.

Returning to FIG. 2, a packet generation scheme may include using a packet number that is constructed from a base packet number (BPN) and a sequence number contained in the WUR frame (i.e., the transmitted frame). The base packet number may be locally stored at the STA 115-a. In some examples, the packet number may be 8 bytes in length. The AP 105-a may only transmit 12 (or any other value) bits of the 8 bytes of the packet number (e.g., the 12 MSBs or the 16 LSBs) as a sequence number. Once the STA 115-a receives the transmitted bits from the AP 105-a, the STA 115-a may use the locally stored 6 bytes to construct the packet number. As such, even though the sequence number may rotate periodically or aperidoically, the packet number itself may not because it has the other 6 bytes locally stored, which is increased by one unit every time the sequence number goes from a high sequence number value to a low sequence number value.

In this packet generation scheme, the STA 115-a may maintain a packet number for each transmitter address (TA) (e.g., TA of AP 105-a) and each receiver ID (e.g., wakeup radio 135-a ID of STA 115-a and other STAs in a BSS of the AP 105-a). For example, at the AP 105-a, a set of packet numbers that is proportional to the number of IDs for transmitted protected WUR frames (e.g., up to 4096) may be maintained. The STA 115-a may maintain a number of packet numbers that is proportional to the number of IDs that it is interested in. If only individual WUR frames are of interest, then the STA 115-a may maintain a single packet number for its wakeup radio 135-a ID. Alternatively, if the STA 115-a has negotiated group IDs, then the STA 115-a may maintain, for example, 64 packet numbers. Additionally, or alternatively, if the STA 115-a is interested in broadcast, then another packet number for the transmit ID may be maintained. Using the above scheme, the STA 115-a may receive a WUR frame, identify a sequence number in the received WUR frame, and generate a packet number based on the identified sequence number and the base packet number. In some cases, the base packet number may be locally stored by the STA 115-a.

The STA 115-a may additionally, or alternatively be configured with a different packet generation scheme that may include using a packet number that is constructed from a base timing synchronization function (TSF) and a partial TSF contained in the WUR frame (i.e., the transmitted frame). In some cases, the base TSF may be locally stored by the STA 115-a. The partial TSF may allow the STA 115-a to synchronize its clock to match the clock of the AP 105-a. The partial TSF may also allow the STA 115-a to prevent and/or avoid replay attacks. In some examples, the ID may correspond to the wakeup radio 135-a ID of the STA 115-a solely, if the WUR frame is individually addressed; or a group ID if the WUR frame is group addressed, or a TD transmit ID if the WUR frame is broadcasted.

In some cases, the STA 115-a may update a local TSF (e.g., a TSF maintained or stored by the STA 115-a) to account for, for example, clock drift between the AP 105-a and the STA 115-a. For example, in some cases clocks (e.g., TSFs) maintained at the AP 105-a and the STA 115-a may drift from each other (e.g., account for time differently) based on differing clock speeds (e.g., clock oscillator frequencies). As such, STA 115-a may, in some cases, update its local TSF based on, or otherwise account for, possible clock drift between the STA 115-a and the AP 105-a.

For example, STA 115-a may determine a clock drift offset (e.g., between the local TSF and the TSF of AP 105-a) by multiplying an estimated clock drift by the time between receiving the latest TSF from the AP 105-a and updating the internal TSF (e.g., partial TSF in the preceding WUR frame or a beacon frame received from the AP) and the time at which the most recent WUR frame containing the partial TSF is received. The estimated clock drift may be determined based on two or more received TSF values from the AP 105-a and the STA 115-a comparing these to the local TSF at the STA 115-a. That is, STA 115-a may estimate clock drift based on a comparison of the partial TSF values received in two WUR frames or two beacon frames with the two corresponding local TSF values (e.g., the local TSF value at each WUR frame receive instance). The STA 115-a may then determine a clock drift offset by multiplying the estimated clock drift by the time or duration elapsed between the two received WUR frames and the latest instance at which the local TSF was synchronized with a received TSF from the AP 105-a.

The STA 115-a may account for the determined clock drift offset, for example, by accounting for clock drift when generating packet numbers (e.g., for additional authentication data (AAD) or packet replay avoidance techniques), etc. For example, a partial TSF timestamp received in a WUR frame may be adjusted or updated by the STA 115-a to consider the STA 115-a delay and clock drift. In some cases, the adjusted TSF (the partial TSF information adjusted by the STA 115-a) may be used by the STA 115-a to generate a packet number for replay packet avoidance techniques. For example, STA 115-a may create a temporary timestamp by concatenating the received partial TSF timestamp (e.g., the AP 105-a partial TSF received in the WUR frame) with 9 bits containing an implementation specific value that represents the assumed value of bit position 0 to 8 of temporal timestamp. The STA 115-a may then add an amount equal to the STA's 115-a delay through its local PHY components plus the time since the first bit of the partial TSF field was received at the MAC/PHY interface to the temporal timer, and may further add the determined clock drift offset to the temporal timer. In some cases, the adjusted value of the received partial TSF timestamp may be set as the value of bit position 9 to 16 of the temporal timestamp. In some cases, the STA 115-a may determine when to update the local TSF. In some cases, the AP 105-a may transmit an indication to for the STA 115-a to update its local TSF (e.g., in a common IPN field of a WUR frame). In some cases, STA 115-a may add the clock drift offset to the local TSF timer to determine a packet number (PN) for a frame received from AP 105-a and subtract the clock drift offset to the local TSF timer to determine a PN for a frame to be transmitted to AP 105-a. In some cases, STA 115-a may determine the clock drift offset by multiplying the estimated clock drift by the time between receipt or intended transmission of the frame and the latest moment at which the local TSF was synchronized with the TSF of AP 105-a.

Using this packet generation scheme, it may be unnecessary for the AP 105-a to maintain any packet numbers since it is already maintaining TSF for synchronization with the STA 115-a. Similarly, it may also be unnecessary for the STA 115-a to maintain any packet numbers since it too is maintaining TSF for synchronization with the AP 105. The STA 115-a may also maintain a single packet number for each TA since the TSF may be common for all STAs in a BSS of the AP 105-a. In some cases using the above described packet generation scheme, the AP 105-a may be uncapable of determining a message integrity code (MIC) of the transmitted WUR frame within a time interval that may ensure that the transmitted partial TSF does not change within the time interval (e.g., 32 μs or 256 μs). In some cases, the AP 105-a may be capable of determining the MIC of the transmitted WUR frame. In this case, the AP 105-a may determine the MIC of the transmitted WUR frame and PPDU transmitted before incrementing a value in the partial TSF field of the WUR frame. In some cases, a TSF timer may be corrupted, and the STA 115-a may become unsynchronized with scheduled transmissions from the AP 105-a (e.g., and as a result may discard WUR frames). By using a packet generation scheme as described above, the STA 115-a may decrease or eliminate instances of becoming unsynchronized with the AP 105-a.

The AP 105-a may determine the packet number generation scheme for the STA 115-a to use for constructing a packet number for a WUR frame, and provide an indication of the scheme to the STA 115-a (e.g., during association with the STA 115-a). For example, when setting up a WUR BSS, a WUR operation element or some other element may have a bit that indicates whether packet numbers are constructed using a TSF timer or sequence numbers.

As further described herein, a full packet number may be monotonically increasing. In some cases, an over-the-air number (e.g., wirelessly communicated from AP 105-a to a STA 115-a), may be concatenated with a base number to get the full packet number.

For example, the AP 105-a may decide whether it will use a common IPN (e.g., the TSF timer) that may apply to all (e.g., both broadcast and individually addressed) protected WUR frames, or whether it will use an IPN for each <Address, Embedded BSSID> couple (e.g., a transmitter-receiver couple or pair). That is, an AP 105-a that intends to transmit protected WUR frames may set the Common IPN field in the WUR Operation element to 0 if it intends to maintain separate IPN counters for each <Address, Embedded BSSID> couple, or may set the Common IPN field to 1 if it intends to maintain a common IPN for all protected WUR frames generated within its BSS.

When the common IPN field is equal to 0,

IPN=PN0∥PN1∥PN2|PN3∥PN4∥PN5

where the IPN may be incremented by one for each transmitted WUR medium access control (MAC) management protocol data unit (MPDU) using the same temporal key and <Address, Embedded BSSID> couple. The IPN may be unique for protected WUR frames generated using the same temporal key and <Address, Embedded BSSID>. AP 105-a may include PN0∥PN1[0:3] (e.g., the PPN) in the Counter and Sequence Number subfields of the TD Control field 320 of the transmitted WUR frame. When the common IPN field is equal to 1,

IPN=PN0∥PN1∥PN2∥PN3∥PN4∥PN5=TSF timer [8:55]

The IPN may be unique for protected WUR frames generated within that BSS using the same temporal key. The AP 105-a may include PN0 (e.g., TSF timer [8:15]) in the Sequence Number of the TD Control field 320 of the transmitted WUR frame.

The receiving STA (e.g., STA 115-a) may generate or construct the remainder of the IPN locally using the information received in the WUR frame (e.g., the PPN information and the common IPN field). For example, the IPN may be constructed at the STA 115-a locally using the value of the Common IPN field of the most recently received WUR Operation element as well as the Sequence Number subfields of the TD Control field 320. When the Common IPN field is equal to 0, the IPN may be obtained as PPN∥BPN, where PPN may obtained from the TD Control field of the received WUR frame, and BPN may be retrieved from the local storage at the receiver (e.g., at STA 115-a). For example,

PN0=PN1[0:3]=PPN and PN1[4:7]∥PN2∥PN3∥PN4∥PN5=BPN

When the Common IPN field is equal to 1, the IPN may be obtained as PPN∥BPN, where PPN may be obtained from the TD Control field of the receiver WUR frame, and BPN may be retrieved from the local storage at the receiver (e.g., at STA 115-a). For example,

PN0=PPN and PN1∥PN2∥PN3∥PN4∥PN5=BPN

The locally stored BPN may be initialized at 0 when a secure link is established and the most recently received Common IPN field sent by the AP 105-a is 0. The locally stored BPN may be initialized at the local value of the TSF timer [8:55] when the most recently received Common IPN field sent by the AP 105-a is 1. The BPN may be updated explicitly through a secure header compression request/response exchange (e.g., through exchanging protected management frames between the STA 115-a and the AP 105-a via the primary radio). The AP 105-a may signal the BPN for group addressed frames to receiving STAs if the BPN is not equal to zero

In other examples, the STA 115-a may request or negotiate a packet number generation scheme with the AP 105-a. The packet number generation scheme may also be based on a mode of the STA 115-a (i.e., a mode of the wakeup radio 135-a). For example, if the wakeup radio 135-a is always ON, then the AP 105-a may configure the STA 115-a to use a first packet number generation scheme, and if the mode of the wakeup radio 135-a is in a duty-cycle, then the AP105-a may configure the STA 115-a to use a second packet number generation scheme different from the first.

In some cases, the AP 105-a may configure the STA 115-a with a packet number generation scheme based on a number of intended receivers using sequence number for individually addressed WUR frames, and use partial TSF for group addressed and/or broadcasted WUR frames. That is, the AP 105-a may identify a first packet number generation scheme when the WUR frame is addressed to a plurality of STAs or a group of STAs, and identify a second scheme packet number generation scheme when the WUR frame is individually addressed to the STA 115-a. The AP 105-a may additionally, or alternatively, configure the STA 115-a with a packet number generation scheme based on a frame type associated with the WUR frame. For example, the AP 105-a may configure the STA 115-a to use TSF for WUR beacon and use sequence number for WUR frame.

That is, in some cases, the packet number (e.g., IGTK packet number) generation for a WUR frame may depend on whether the WUR frame is broadcast or individually addressed. For example, the AP 105-a may generate the IPN (e.g., and configure the STA 115-a with a packet number generation scheme) using the TSF timer for broadcast WUR frames, and may otherwise generate the IPN (e.g., and configure the STA 115-a with a packet number generation scheme) using a sequence number or a partial sequence number (e.g., that is carried in the frame).

If AP 105-a intends to broadcast a protected WUR frame, the AP 105-a may construct an IPN using a TSF timer at the AP 105-a at the instant of time at which the WUR frame is generated. For example, AP 105-a may generate or construct the IPN as,

IPN=PN0∥PN1∥PN2∥PN3∥PN4∥PN5=TSF timer[9:56]

In some cases, other indices (e.g., indices other than [9:56]) may be used. For example, in some cases, the TSF timer indices may start from 0. The TSF timer indices may indicate the portion of the TSF timer used as the IPN. For example, the TSF timer may include 8 bytes of information, and the IPN may include 6 bytes of information, with the 6 bytes of information corresponding to the partial TSF timer information indicated by the indices (e.g., the [9:56] partial information, or 6 bytes, of the TSF timer information). The IPN may be unique (e.g., not repeated, as the TSF timer information may not repeat) for protected WUR frames generated using the same temporal key and <transmit ID, Embedded BSSID> couple. In some cases, AP 105-a may include PN0 (e.g., the 8 least significant bits (LSBs) of the packet number), which may be equal to the AP 105-a TSF timer [9, 15], in the Sequence Number subfield of the TD control field of the WUR wakeup frame. In some cases, the remaining portion of the IPN may be locally stored. That is, AP 105-a may protect a broadcast WUR frame (e.g., via message integrity check techniques) using an IPN constructed as described above.

If AP 105-a intends to individually address a protected WUR frame to a STA (e.g., or in some cases groupcast a protected WUR frame addressed to one or more STAs), the AP 105-a may generate or construct the IPN using a sequence number. For example, AP 105-a may generate or construct the IPN as,

IPN=PN0∥PN1∥PN2∥PN3∥PN4∥PN5

where the IPN may be incremented by one for each transmitted WUR frame using the same temporal key and <Address, Embedded BSSID> couple (e.g., where the Embedded BSSID field may be the identifier of the transmitter, and the Address field may be the identifier of the receiver). The IPN may be unique for protected WUR frames generated using the same temporal key and <Address, Embedded BSSID> couple. In some cases, AP 105-a may include PN0∥PN1[0:3] (e.g., the PN0+4 LSBs of PN1, of the IPN) in the Sequence Number subfield of the TD Control field of the WUR Wake Up frame.

The receiving STA (e.g., STA 115-a) may generate or construct the remainder of the IPN locally using the information received in the WUR frame. If the WUR frame is broadcast, the IPN may be obtained as PPN∥BPN, where PPN is equal to the value of the Sequence Number field (e.g., a Sequence Number subfield of TD control field 320) of the received WUR frame, and BPN may retrieved from the local TSF timer [16:56] at the receiver (e.g., the local TSF timer [16:55] at the STA 115-a). That is,

PN0=PPN and PN1∥PN2∥PN3∥PN4∥PN5=BPN

Otherwise (e.g., when the WUR frame is individually addressed or group addressed), the IPN may be obtained as PPN∥BPN, where PPN is equal to the value of the Sequence Number field of the received WUR frame, and BPN may be retrieved from the local TSF timer [16:56] at the receiver. That is,

PN0∥PN1[0:3]=PPN and PN1[4:7]∥PN2∥PN3∥PN4∥PN5=BPN

The locally stored BPN may be initialized at 0 when a non-broadcast link is established, and may be initialized at the value of the local TSF timer [8:56] when a broadcast link is established. The BPN may be updated explicitly through a secure header compression request/response exchange (e.g., through exchanging protected management frames between the STA 115-a and the AP 105-a via the primary radio). The AP 105-a may signal the BPN for group addressed frames to receiving STAs if the BPN is not equal to zero.

The STA 115-a may also support key maintenance and management for protecting the WUR frame. A key for protecting WUR frames may be a PTK or an IGTK. A PTK may be defined as a concatenation of session keys derived from a pairwise master key (PMK) or from a PMK-R1. That is, a PMK may include a key confirmation key (KCK), a key encryption key (KEK), and a temporary key (TK), which may be used to protect information exchanged between the AP 105-a and the STA 115-a. Alternatively, the IGTK may be defined as a random value, which may be assigned by a broadcast or multicast source STA (e.g., STA 115-a) in a BSS of the AP 105-a. The IGTK may be used to protect a group of addressed MPDUs from the source STA.

In some cases, the STA 115-a may have a preference between using a PTK over an IGTK for protecting a WUR frame. For example, the STA 115-a may refrain from using IGTK because of its visibility to all STAs associated with a same BSS. The STA 115-a may also be more prone to attacks from STAs in the BSS that may be compromised STAs (e.g., attackers). In contrast PTK may be imperceptible, and as a result an attack from a compromised STA may be unlikely. In some cases, the STA 115-a may, regardless of its preference, use IGTK. For example, since the STA 115-a may have a group addressed WUR frame, it may use IGTK to protect the WUR frame. The STA 115-a may be configured to recognize when to use PTK or IGTK to protect a WUR frame, such that the STA 115-a may dynamically adjust its key maintenance and management for protecting the WUR frame. For example, the STA 115-a may use IGTK for all protected WUR frames that are group addressed, and those identified by a group ID, or transmit ID. Alternatively, the STA 115-a may use PTK for all protected WUR frames that are individually addressed.

The key maintenance and management scheme described above may not be limited. That is, the STA 115-a may use IGTK on protected WUR frames that are individually addressed to the STA 115-a by signaling to the AP 105-a to use IGTK on WUR frames addressed to the STA 115-a. The signaling between using PTK and IGTK for WUR frames may be triggered by the AP 105-a transmitting an indication to the STA 115-a indicating to the STA 115-a which key (e.g., PTK or IGTK) will be used for one or more of the IDs that the STA 115-a is maintaining. The AP 105-a may, in some cases, dynamically switch between keys. For example, the AP 105-a may use a PTK when allocating a group ID only to STA 115-a, and if the AP 105-a decides to allocate the same group ID to another different STA the AP 105-a can switch to using IGTK.

In some cases, the STA 115-a may use the same PTK or IGTK that it uses for communication on the primary radio 130-a. The STA 115-a may use the same PTK or IGTK that it uses for frame exchanges on the primary radio 130-a. In this case, the STA 115-a may be configured with one or more rules for packet number generation schemes and key maintenance and management schemes at the primary radio 130-a and the wakeup radio 135-a separately. Alternatively, the STA 115-a (and AP 105-a) may choose to derive IGTKs and PTKs that may be independent of the ones used by the primary radio 130-a. For example, during a four-way handshake exchange between the STA 115-a and the AP 105-a during authentication, a bit or some signaling may be used to explicitly indicate that the IGTK or PTK derivation is for the primary radio 130-a or for the wakeup radio 135-a.

For example, a four-way handshake exchange between the STA 115-a and the AP 105-a may include the AP 105-a sending a nonce-value (ANonce) to the STA 115-a together with a key replay counter. The key replay counter may be used to match pairs of messages sent, discarding replayed messages. STA 115-a may then construct the PTK. STA 115-a may also send to the AP 105-a a nonce-value (SNonce) together with a MIC, including authentication. In some examples, the MIC may be referred to as a message authentication and integrity code (MAIC), and the key replay counter may be considered to be the same as Message 1, which may allow AP 105-a to match to the correct Message 1. AP 105-a may verify Message 2, by checking MIC, robust security network (RSN), ANonce and the key replay counter field, and if valid these are valid, AP 105-a may construct a GTK with another MIC, and send the GTK-MIC to the STA 115-a. STA 115-a may verify Message 3, for example by checking MIC and key replay counter field, and if valid sends a confirmation to AP 105-a. In some examples the indication of the second key to be used by the WUR may be transmitted in one or more of these messages between 115-a and AP 105-a described above in the four-way handshake. For example, an indication that the STA 115-a is to use one of the same key (first key) as the primary radio, or a second key different from the first key, to receive protected communications using the wakeup radio may be transmitted in one or more of the ANonce, SNonce+MIC, GTK+MIC, or ACK messages of the four-way handshake. Additionally or alternatively, one or more of the messages of the four-way handshake may be used to convey or indicate other of the indications described here. For example, in some cases, the one or more of the messages of the four-way handshake may be used to convey the second key.

Configuration of the STA 115-a with a plurality of packet number generation schemes for constructing a packet number for a WUR frame, as well as key maintenance and management schemes for protecting the WUR frame, may reduce or eliminate replay attacks, while also improving security in the WLAN 200. That is, WUR frame protection targets message integrity check (e.g., ensuring that the WUR frame is transmitted by a trusted STA). However, the WUR frame contents are still sent over the open interface (e.g., no encryption). This is because encryption may be computationally extensive. However, in certain use cases, the STA 115-a and the AP 105-a may negotiate the additional encryption of the WUR frames (or a subgroup of them). This may be achieved during the negotiation of WUR mode operation (STA 115-a and AP 105-a may negotiate encryption of the WUR frames between each other), may be enabled by the AP 105-a (e.g., a bit in a WUR operation element indicates that WUR frames are encrypted), etc.

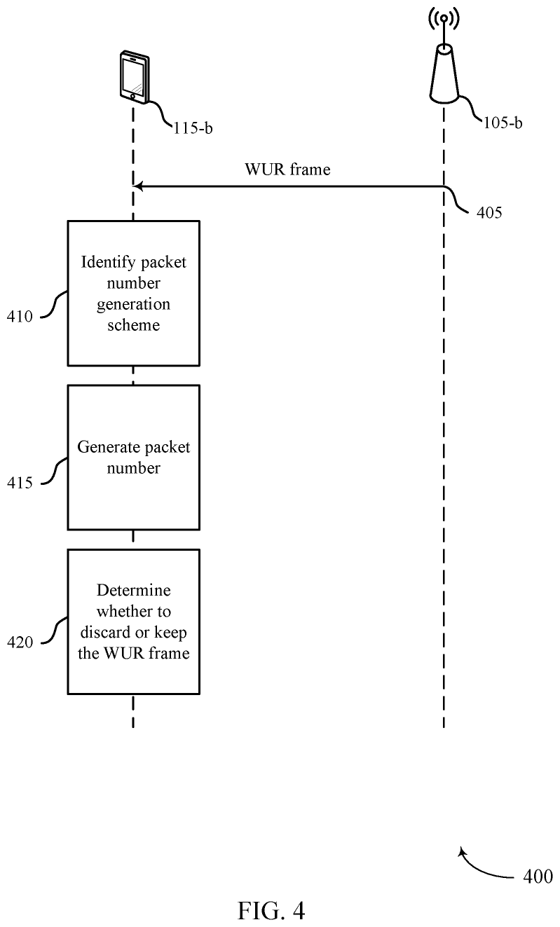

FIG. 4 illustrates an example of a process flow 400 that supports key and packet number management for WUR frames in accordance with aspects of the present disclosure. In some examples, the process flow 400 may implement aspects of WLAN 100 and/or WLAN 200. For example, the process flow 400 may include AP 105-b and STA 115-b, which may be examples of the corresponding devices described with reference to FIGS. 1 and 2, may support packet number generation schemes.

In the following description of the process flow 400, the operations between the AP 105-b and the STA 115-b may be transmitted in a different order than the exemplary order shown, or the operations performed by the AP 105-b and the STA 115-b may be performed in different orders or at different times. Certain operations may also be left out of the process flow 400, or other operations may be added to the process flow 400.

At 405, the AP 105-b may transmit a WUR frame to the STA 115-b. At 410, the STA 115-b may identify a scheme to use to construct a packet number for the WUR frame. The scheme may be a packet number generation scheme that may be selected from a plurality of such packet number generation schemes. In some examples, prior to receiving the WUR frame, the STA 115-b may receive (e.g., during association with the AP 105-b) an indication of the scheme that the STA 115-b is to use to construct the packet number. In some cases, the STA 115-b may transmit (e.g., during the association with the AP 105-b) a request identifying one of the plurality of packet number generation schemes. In some cases, the STA 115-b may identify a mode of operation for a wakeup radio (e.g., for a wakeup radio 135) of the STA 115-b , and may identify the scheme based on the mode of operation of the wakeup radio. In some cases, the STA 115-b may identify a frame type associated with the received WUR frame, and may identify a scheme based on the frame type.

At 415, the STA 115-b may generate a packet number (e.g., corresponding to the WUR frame received at 450). For example, the STA 115-b may generate a packet number for the WUR frame based on a scheme used by the AP 105-b to construct packet numbers (e.g., identified at 410). In some cases, the STA 115-b may generate the packet number using a sequence number identified in the WUR frame and a base packet number locally stored at the STA 115-b . Alternatively, the STA 115-b may generate the packet number using a partial TSF in the received WUR frame and a base TSF. In some cases, the base TSF may be stored locally at the STA 115-b.

At 420, the STA 115-b may determine whether to discard the WUR frame or keep the WUR frame. For example, the STA 115-b may determine whether to discard the WUR frame or keep the WUR frame based on the generated packet number. In some cases, the STA 115-b may discard the WUR frame based on determining that the WUR frame is a repeated WUR frame (e.g., based on the generated packet number being a repeat, or matching a packet number of a WUR frame previously received). Alternatively, the STA 115-b may keep the WUR frame based on determining that the WUR frame is not a repeated WUR frame (e.g., based on determining the received WUR frame is not a WUR frame previously transmitted by AP 105-b). In some cases, using such a packet number generation scheme for constructing a packet number for the WUR frame (e.g., received by STA 115-b at 405) may reduce or eliminate replay attacks.

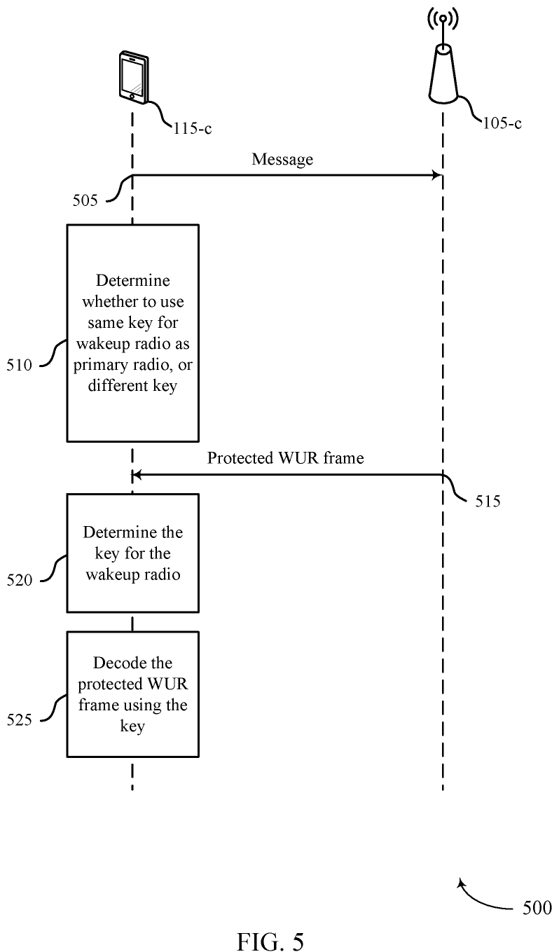

FIG. 5 illustrates an example of a process flow 500 that supports key and packet number management for WUR frames in accordance with aspects of the present disclosure. In some examples, the process flow 500 may implement aspects of WLAN 100 and/or WLAN 200. For example, the process flow 500 may include AP 105-c and STA 115-c, which may be examples of the corresponding devices described with reference to FIGS. 1 and 2, may support key maintenance and management schemes.

In the following description of the process flow 500, the operations between the AP 105-c and the STA 115-c may be transmitted in a different order than the exemplary order shown, or the operations performed by the AP 105-c and the STA 115-c may be performed in different orders or at different times. Certain operations may also be left out of the process flow 500, or other operations may be added to the process flow 500.

At 505, the STA 115-c may transmit a message to the AP 105-c. For example, the STA 115-c may transmit an indication of a preference to use a same key or a second key for protecting frames. In some examples, the second key may be different from a first key used by the STA 115-c to receive protected frames from the AP 105-c using a primary radio of the STA 115-c. In some cases, the first key may be an individual key for the STA 115-c, and the second key may be a group key for a group of STAs (e.g., for a group of STAs that includes the STA 115-c). Alternatively, the first key may be a group key for a group of STAs that includes the STA 115-c, and the second key may be an individual key for the STA 115-c. In some cases, the first key may be an individual key for the STA to be used for communications via the primary radio, and the second key may be an individual key for the STA to be used for communications via the wakeup radio (e.g., where the first key comprises a first PTK and the second key comprises a second PTK). In some cases, the first key may be a group key for the STA to be used for communications via the primary radio, and the second key may be a group key for the STA to be used for communications via the wakeup radio (e.g., where the first key comprises a first IGTK, and the second key comprises a second IGTK).

At 510, the STA 115-c may determine whether to use a same key or a second key (e.g., IGTK) different from the first key (e.g., PTK) used to receive protected communications using a primary radio of the STA 115-c (e.g., primary radio 130). In some cases, the STA 115-c may add a bit to the first key to generate the second key based on identifying that a wakeup radio of the STA 115-c is to use the second key. In cases where the PTK or IGTK between a primary radio and a wakeup radio is the same, the radios may be differentiated by a bit that may be appended to the key. That is, the second key may be different from the first key for the primary radio of the STA 115-c by at least one bit (e.g., a single bit), the one bit indicating that the second key is for the wakeup radio. For example, a bit having a value “0” may indicate that the key is PTK for the primary radio and a bit having a value “1” may indicate that the key is PTK for the wakeup radio. Generally, the second key may be different from the first key for the primary radio in the value of at least one bit (e.g., where any differing bit in the value of the second key compared to the first key may indicate the second key is for the wakeup radio). Alternatively, a bit value may indicate when the PTK or the IGTK used for the wakeup radio is derived from the PTK or IGTK of the primary radio. The STA 115-c may alternatively, apply a function to the first key for the AP 105-c to generate the second key for the STA 115-c based on identifying that the wakeup radio of the STA 115-c is to use the second key (e.g., the applied function may be known to both the AP 105-c and STA 115-c).

At 515, the AP 105-c may transmit a protected WUR frame to the STA 115-c. At 520, the STA 115-c may determine the key for the wakeup radio. For example, the STA 115-c may derive the second key from the first key. The second key may be different from the first key for the primary radio by at least one bit (e.g., one bit may indicate that the second key is for the wakeup radio of the STA 115-c). In some examples, the STA 115-c may determine the second key for the STA 115-c to use based at least in part on the first key used by the primary radio of the STA 115-c. The STA 115-c may, in some cases, add a bit to the first key to generate the second key based at least in part on identifying that the wakeup radio is to use the second key. Alternatively, the STA 115-c may apply a function to the first key to generate the second key based at least in part on identifying that the wakeup radio is to use the second key (e.g., the applied function may be known to both the AP 105-c and the STA 115-c). At 525, the STA 115-c may decode the WUR frame based on using the determined key from 510 (e.g., the same key or the second key). In some cases, using such key maintenance and management schemes for protecting the WUR frame may improve security for communicating frames between the AP 105-c and the STA 115-c.

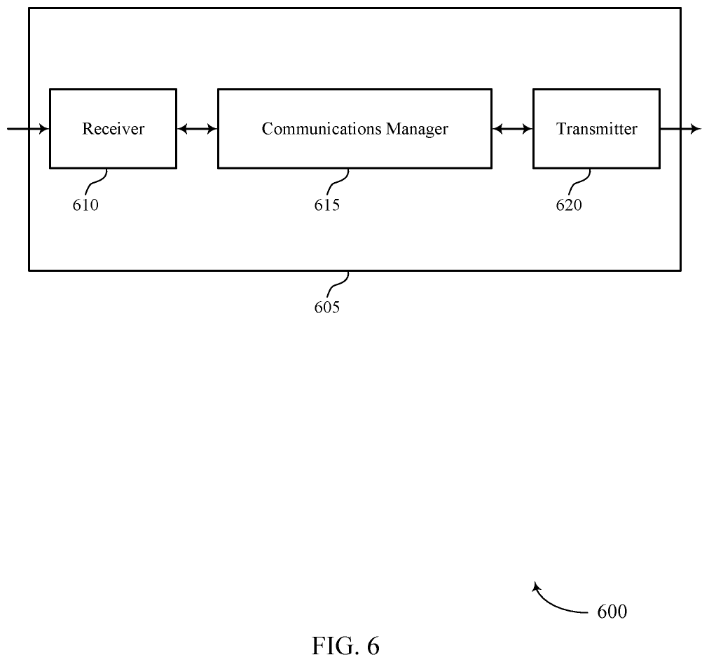

FIG. 6 shows a block diagram 600 of a device 605 that supports key and packet number management for WUR frames in accordance with aspects of the present disclosure. The device 605 may be an example of aspects of an AP as described herein. The device 605 may include a receiver 610, a communications manager 615, and a transmitter 620. The device 605 may also include a processor. Each of these components may be in communication with one another (e.g., via one or more buses).

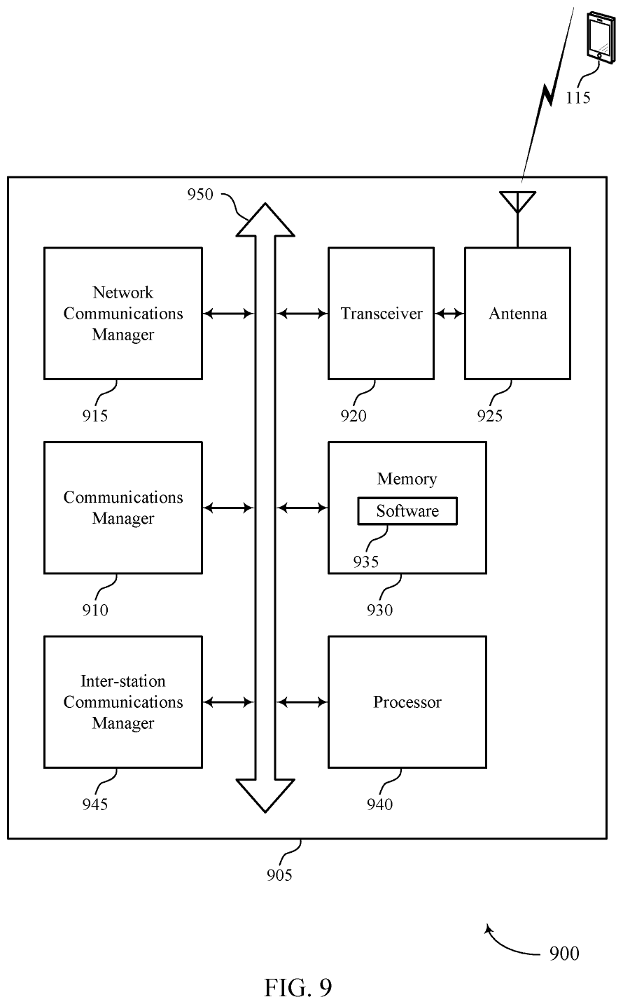

The receiver 610 may receive information such as packets, user data, or control information associated with various information channels (e.g., control channels, data channels, and information related to key and packet number management for WUR frames, etc.). Information may be passed on to other components of the device. The receiver 610 may be an example of aspects of the transceiver 920 described with reference to FIG. 9. The receiver 610 may utilize a single antenna or a set of antennas.

The communications manager 615 may determine, from among a set of packet number generation schemes, a scheme that a STA is to use to construct a packet number for a WUR frame, generate the WUR frame based on the determined scheme, the generated WUR frame including an indication of the determined scheme, and transmit the generated WUR frame to the STA. The communications manager 615 may be an example of aspects of the communications manager 910 described herein.

The communications manager 615, or its sub-components, may be implemented in hardware, code (e.g., software or firmware) executed by a processor, or any combination thereof. If implemented in code executed by a processor, the functions of the communications manager 615, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 615, or its sub-components, may be physically located at various positions, including being distributed such that portions of functions are implemented at different physical locations by one or more physical components. In some examples, the communications manager 615, or its sub-components, may be a separate and distinct component in accordance with various aspects of the present disclosure. In some examples, the communications manager 615, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The communications manager 615, or its sub-components may be implemented by a wireless modem. The wireless modem may be coupled to the receiver 610 over a first interface and coupled to the transmitter 620 over a second interface. In some examples, the wireless modem may obtain messages and signaling received at the receiver 610 over the first interface. In other examples, the wireless modem may output or provide messages or signaling for transmission by the transmitter 620 over a second interface.

The transmitter 620 may transmit signals generated by other components of the device. In some examples, the transmitter 620 may be collocated with a receiver 610 in a transceiver module. For example, the transmitter 620 may be an example of aspects of the transceiver 920 described with reference to FIG. 9. The transmitter 620 may utilize a single antenna or a set of antennas.

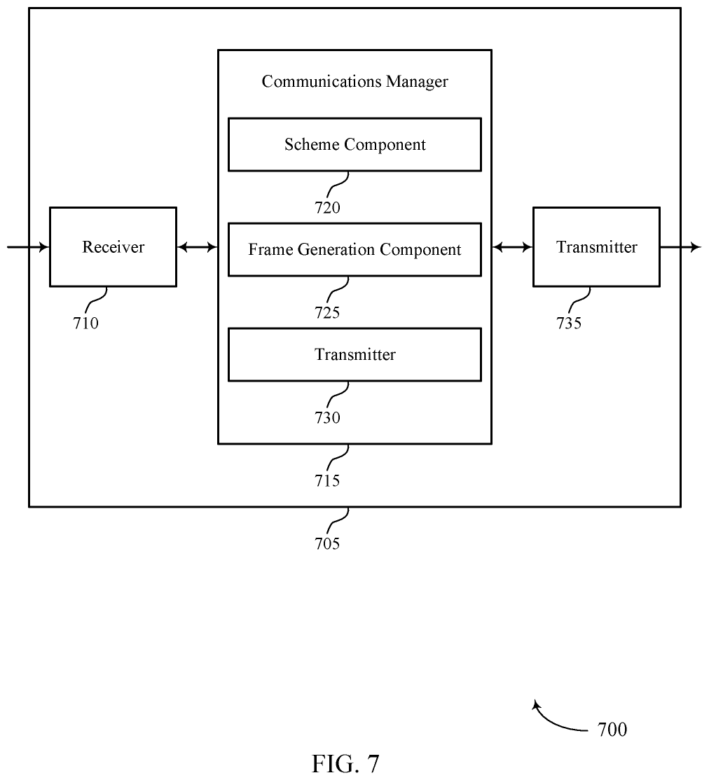

FIG. 7 shows a block diagram 700 of a device 705 that supports key and packet number management for WUR frames in accordance with aspects of the present disclosure. The device 705 may be an example of aspects of a device 605 or an AP (e.g., AP 105) as described herein. The device 705 may include a receiver 710, a communications manager 715, and a transmitter 735. The device 705 may also include a processor. Each of these components may be in communication with one another (e.g., via one or more buses).

The receiver 710 may receive information such as packets, user data, or control information associated with various information channels (e.g., control channels, data channels, and information related to key and packet number management for WUR frames, etc.). Information may be passed on to other components of the device. The receiver 710 may be an example of aspects of the transceiver 920 described with reference to FIG. 9. The receiver 710 may utilize a single antenna or a set of antennas.

The communications manager 715 may be an example of aspects of the communications manager 615 as described herein. The communications manager 715 may include a scheme component 720, a frame generation component 725, and a transmitter 730. The communications manager 715 may be an example of aspects of the communications manager 910 described herein.

The scheme component 720 may determine, from among a set of packet number generation schemes, a scheme that a STA is to use to construct a packet number for a WUR frame. The frame generation component 725 may generate the WUR frame based on the determined scheme, the generated WUR frame including an indication of the determined scheme. The transmitter 730 may transmit the generated WUR frame to the STA.

The transmitter 735 may transmit signals generated by other components of the device. In some examples, the transmitter 735 may be collocated with a receiver 710 in a transceiver module. For example, the transmitter 735 may be an example of aspects of the transceiver 920 described with reference to FIG. 9. The transmitter 735 may utilize a single antenna or a set of antennas.

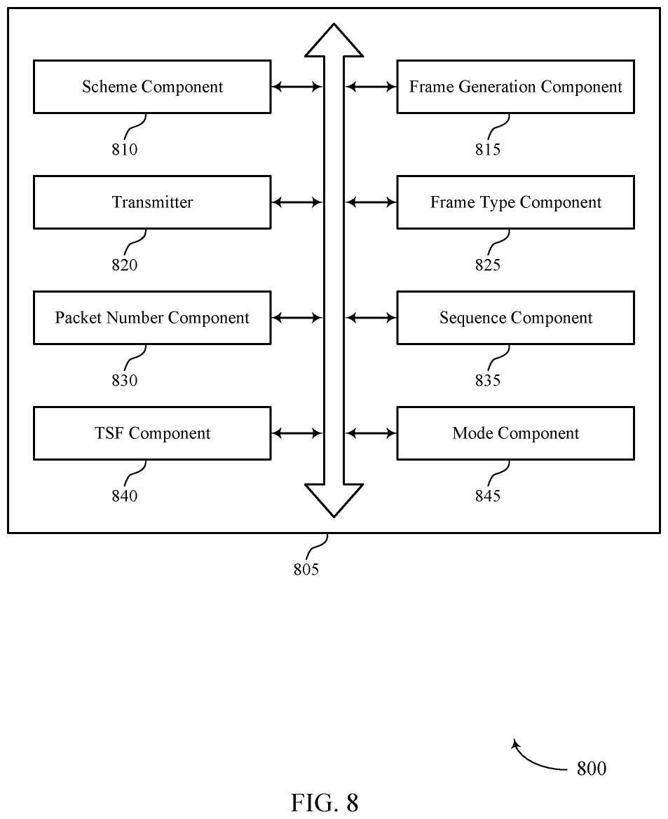

FIG. 8 shows a block diagram 800 of a communications manager 805 that supports key and packet number management for WUR frames in accordance with aspects of the present disclosure. The communications manager 805 may be an example of aspects of a communications manager 615, a communications manager 715, or a communications manager 910 described herein. The communications manager 805 may include a scheme component 810, a frame generation component 815, a transmitter 820, a frame type component 825, a packet number component 830, a sequence component 835, a TSF component 840, and a mode component 845. Each of these modules may communicate, directly or indirectly, with one another (e.g., via one or more buses).

The scheme component 810 may determine, from among a set of packet number generation schemes, a scheme that a STA is to use to construct a packet number for a WUR frame. In some examples, the scheme component 810 may where the WUR frame is generated based on the determined scheme and a partial TSF of the generated WUR frame. In some examples, the scheme component 810 may determine a first scheme from among the set of packet number generation schemes when the WUR frame is to be addressed to a set of STAs or a group of STAs. In some examples, the scheme component 810 may determine a second scheme from among the set of packet number generation schemes when the WUR frame is to be individually addressed to the STA. In some examples, the scheme component 810 may determine the scheme that the STA is to use to construct the packet number for the WUR frame based on the identified mode of operation for the WUR.

In some examples, the scheme component 810 may identify that the determined scheme that the STA is to use to construct the packet number for the WUR frame is common for all STAs associated with the AP. In some examples, the scheme component 810 may identify that the determined scheme that the STA is to use to construct the packet number for the WUR frame is individual for each STA associated with the AP. In some cases, the indication of the determined scheme includes an address field of the WUR frame indicating that the WUR frame is broadcast, group-addressed, or individually-addressed. In some cases, the determined scheme that the STA is to use to construct the packet number for the WUR frame is common for all STAs associated with the AP or individual for each STA associated with the AP.

The frame generation component 815 may generate the WUR frame based on the determined scheme, the generated WUR frame including an indication of the determined scheme. In some examples, the frame generation component 815 may generate the WUR frame based on the identified sequence number and a base packet number. In some examples, the frame generation component 815 may generate the WUR frame based on the identified partial TSF and a base TSF. In some examples, the frame generation component 815 may generate the WUR frame based on the TSF of the AP. In some examples, the frame generation component 815 may generate the WUR frame based on the packet number that does not repeat for a transmitter-receiver couple.

The transmitter 820 may transmit the generated WUR frame to the STA. The frame type component 825 may determine the WUR frame is individually addressed to the STA, where the scheme is determined based on the determination that the WUR frame is individually addressed. In some examples, the frame type component 825 may where the WUR frame is generated based on the determined scheme and a sequence number of the WUR frame. In some examples, the frame type component 825 may determine the WUR frame is group addressed or is a broadcast WUR frame, where the scheme is determined based on the determination that the WUR frame is group addressed or the determination that the WUR frame is the broadcast WUR frame.

The packet number component 830 may determine the packet number based on the determined scheme, where the WUR frame is generated based on the determined packet number. In some examples, the packet number component 830 may initialize a stored base packet number to a value equal to at least a portion of a local TSF timer. In some examples, the packet number component 830 may transmit an indication that the AP maintains a common packet number for all STAs associated with the AP that is valued for all secure WUR frames generated by the AP.

The sequence component 835 may identify a sequence number based on the determined scheme. In some examples, the sequence component 835 may identify a sequence number for the WUR frame, where the WUR frame is generated based on the identified sequence number and a base packet number for a transmitter-receiver couple associated with the WUR frame. In some cases, the identified sequence number is equal to twelve least significant bits of the packet number of the WUR frame, and the base packet number includes at least a portion of a base packet number stored at the STA.

The TSF component 840 may identify a partial TSF based on the determined scheme. In some examples, the TSF component 840 may identify a TSF of the AP based on the identification that the determined scheme that the STA is to use to construct the packet number for the WUR frame is common for all STAs associated with the AP. In some examples, the TSF component 840 may transmit a first TSF value to the STA in a first WUR frame. In some examples, the TSF component 840 may transmit a second TSF value to the STA in a second WUR frame. In some examples, the TSF component 840 may transmit an indication that the AP maintains separate counters for each transmitter-receiver couple. The mode component 845 may identify a mode of operation for a WUR of the STA. In some examples, the mode component 845 may establish a broadcast link with the STA.

FIG. 9 shows a diagram of a system 900 including a device 905 that supports key and packet number management for WUR frames in accordance with aspects of the present disclosure. The device 905 may be an example of or include the components of device 605, device 705, or an AP as described herein. The device 905 may include components for bi-directional voice and data communications including components for transmitting and receiving communications, including a communications manager 910, a network communications manager 915, a transceiver 920, an antenna 925, memory 930, a processor 940, and an inter-station communications manager 945. These components may be in electronic communication via one or more buses (e.g., bus 950).

The communications manager 910 may determine, from among a set of packet number generation schemes, a scheme that a STA is to use to construct a packet number for a WUR frame, generate the WUR frame based on the determined scheme, the generated WUR frame including an indication of the determined scheme, and transmit the generated WUR frame to the STA.

The network communications manager 915 may manage communications with the core network (e.g., via one or more wired backhaul links). For example, the network communications manager 915 may manage the transfer of data communications for client devices, such as one or more STAs 115.

The transceiver 920 may communicate bi-directionally, via one or more antennas, wired, or wireless links as described above. For example, the transceiver 920 may represent a wireless transceiver and may communicate bi-directionally with another wireless transceiver. The transceiver 920 may also include a modem to modulate the packets and provide the modulated packets to the antennas for transmission, and to demodulate packets received from the antennas. In some cases, the wireless device may include a single antenna 925. However, in some cases the device may have more than one antenna 925, which may be capable of concurrently transmitting or receiving multiple wireless transmissions.

The memory 930 may include RAM and ROM. The memory 930 may store computer-readable, computer-executable code or software 935 including instructions that, when executed, cause the processor to perform various functions described herein. In some cases, the memory 930 may contain, among other things, a BIOS which may control basic hardware or software operation such as the interaction with peripheral components or devices.

Software 935 may include code to implement aspects of the present disclosure, including code to support key and packet number management for WUR frames. Software 935 can be stored in a non-transitory computer-readable medium such as system memory or other memory. In some cases, the software 935 may not be directly executable by the processor but may cause a computer (e.g., when compiled and executed) to perform functions described herein.

The processor 940 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In other cases, a memory controller may be integrated into processor 940. The processor 940 may be configured to execute computer-readable instructions stored in a memory to perform various functions (e.g., functions or tasks supporting key and packet number management for WUR frames).

The inter-station communications manager 945 may manage communications with other AP 105, and may include a controller or scheduler for controlling communications with STAs 115 in cooperation with other APs 105. For example, the inter-station communications manager 945 may coordinate scheduling for transmissions to STAs 115 for various interference mitigation techniques such as beamforming or joint transmission. In some examples, the inter-station communications manager 945 may provide an X2 interface within an LTE/LTE-A wireless communication network technology to provide communication between APs 105.

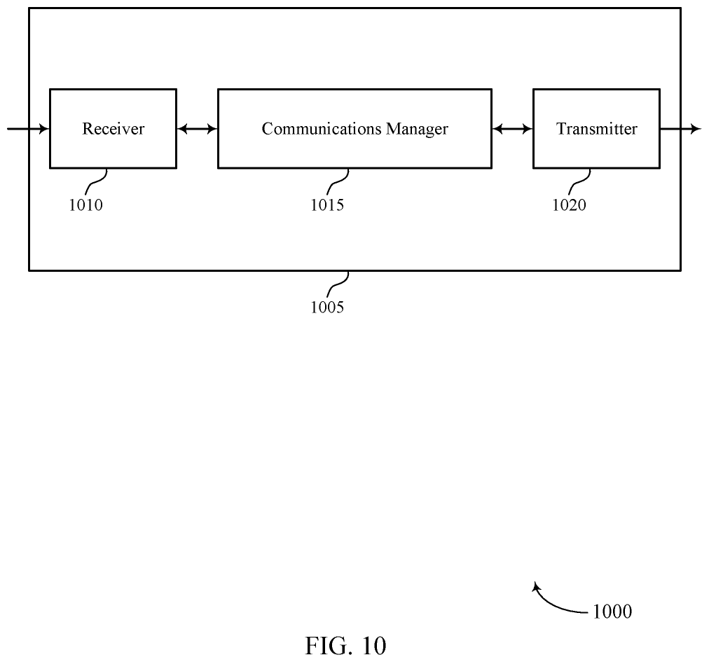

FIG. 10 shows a block diagram 1000 of a device 1005 that supports key and packet number management for WUR frames in accordance with aspects of the present disclosure. The device 1005 may be an example of aspects of a STA as described herein. The device 1005 may include a receiver 1010, a communications manager 1015, and a transmitter 1020. The device 1005 may also include a processor. Each of these components may be in communication with one another (e.g., via one or more buses).

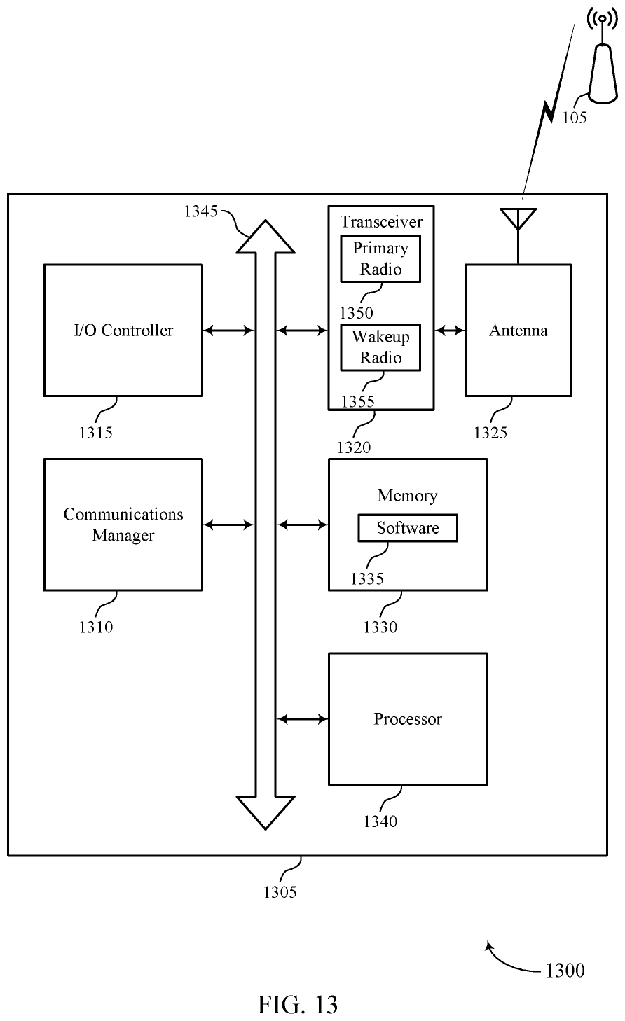

Receiver 1010 may receive information such as packets, user data, or control information associated with various information channels (e.g., control channels, data channels, and information related to key and packet number management for WUR frames, etc.). Information may be passed on to other components of the device. The receiver 1010 may be an example of aspects of the transceiver 1320 described with reference to FIG. 13. The receiver 1010 may utilize a single antenna or a set of antennas.

The communications manager 1015 may receive a WUR frame for the STA at a WUR, identify, from among a set of packet number generation schemes, a scheme that the STA is to use to construct a packet number for the WUR frame, generate a packet number for the received WUR frame based on the identified scheme, and determine whether to discard the WUR frame based on the generated packet number.

The communications manager 1015 may also determine whether the STA is to use, for communications received from an AP to a wakeup radio, a same key or a second key, the second key different from a first key used by the STA to receive protected communications from the AP to a primary radio of the STA, receive a protected WUR frame from the AP, and decode the protected WUR frame based on the same key or the second key. The communications manager 1015 may be an example of aspects of the communications manager 1310 described herein.

The communications manager 1015, or its sub-components, may be implemented in hardware, code (e.g., software or firmware) executed by a processor, or any combination thereof. If implemented in code executed by a processor, the functions of the communications manager 1015, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 1015, or its sub-components, may be physically located at various positions, including being distributed such that portions of functions are implemented at different physical locations by one or more physical components. In some examples, the communications manager 1015, or its sub-components, may be a separate and distinct component in accordance with various aspects of the present disclosure. In some examples, the communications manager 1015, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The communications manager 1015, or its sub-components may be implemented by a wireless modem. The wireless modem may be coupled to the receiver 1010 over a first interface and coupled to the transmitter 1020 over a second interface. In some examples, the wireless modem may obtain messages and signaling received at the receiver 1010 over the first interface. In other examples, the wireless modem may output or provide messages or signaling for transmission by the transmitter 1020 over a second interface.

Transmitter 1020 may transmit signals generated by other components of the device. In some examples, the transmitter 1020 may be collocated with a receiver 1010 in a transceiver module. For example, the transmitter 1020 may be an example of aspects of the transceiver 1320 described with reference to FIG. 13. The transmitter 1020 may utilize a single antenna or a set of antennas.

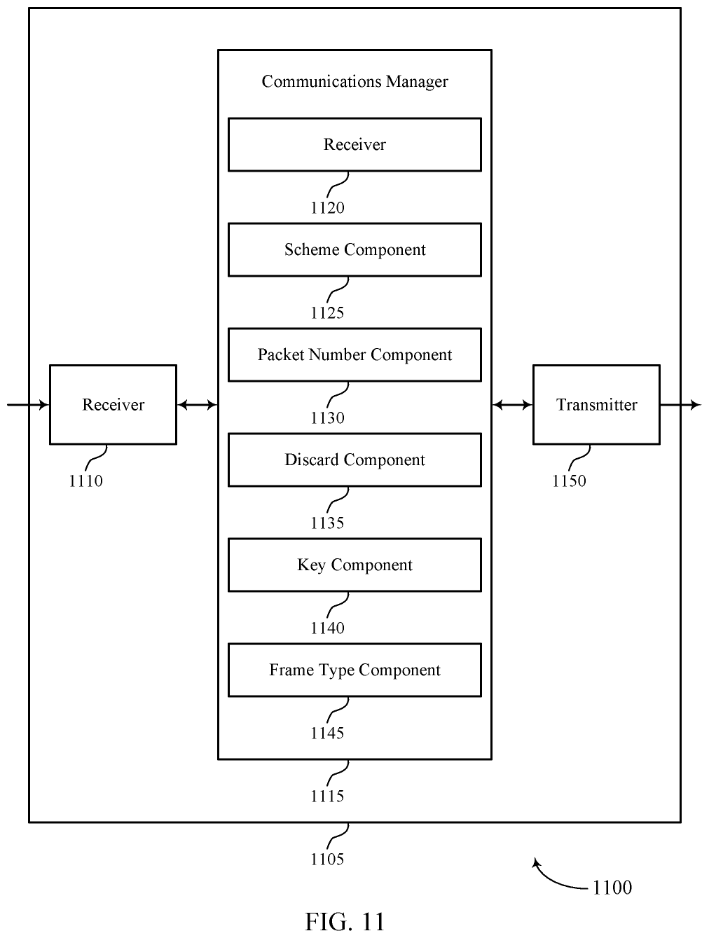

FIG. 11 shows a block diagram 1100 of a device 1105 that supports key and packet number management for WUR frames in accordance with aspects of the present disclosure. The device 1105 may be an example of aspects of a device 1005 or a STA 115 as described herein. The device 1105 may include a receiver 1110, a communications manager 1115, and a transmitter 1150. The device 1105 may also include a processor. Each of these components may be in communication with one another (e.g., via one or more buses).

Receiver 1110 may receive information such as packets, user data, or control information associated with various information channels (e.g., control channels, data channels, and information related to key and packet number management for WUR frames, etc.). Information may be passed on to other components of the device. The receiver 1110 may be an example of aspects of the transceiver 1320 described with reference to FIG. 13. The receiver 1110 may utilize a single antenna or a set of antennas.

The communications manager 1115 may be an example of aspects of the communications manager 1015 as described herein. The communications manager 1115 may include a receiver 1120, a scheme component 1125, a packet number component 1130, a discard component 1135, a key component 1140, and a frame type component 1145. The communications manager 1115 may be an example of aspects of the communications manager 1310 described herein.

The receiver 1120 may receive a WUR frame for the STA at a WUR. The scheme component 1125 may identify, from among a set of packet number generation schemes, a scheme that the STA is to use to construct a packet number for the WUR frame. The packet number component 1130 may generate a packet number for the received WUR frame based on the identified scheme. The discard component 1135 may determine whether to discard the WUR frame based on the generated packet number. The key component 1140 may determine whether the STA is to use, for communications received from an AP to a wakeup radio, a same key or a second key, the second key different from a first key used by the STA to receive protected communications from the AP to a primary radio of the STA. The frame type component 1145 may receive a protected WUR frame from the AP and decode the protected WUR frame based on the same key or the second key.

Transmitter 1150 may transmit signals generated by other components of the device. In some examples, the transmitter 1150 may be collocated with a receiver 1110 in a transceiver module. For example, the transmitter 1150 may be an example of aspects of the transceiver 1320 described with reference to FIG. 13. The transmitter 1150 may utilize a single antenna or a set of antennas.

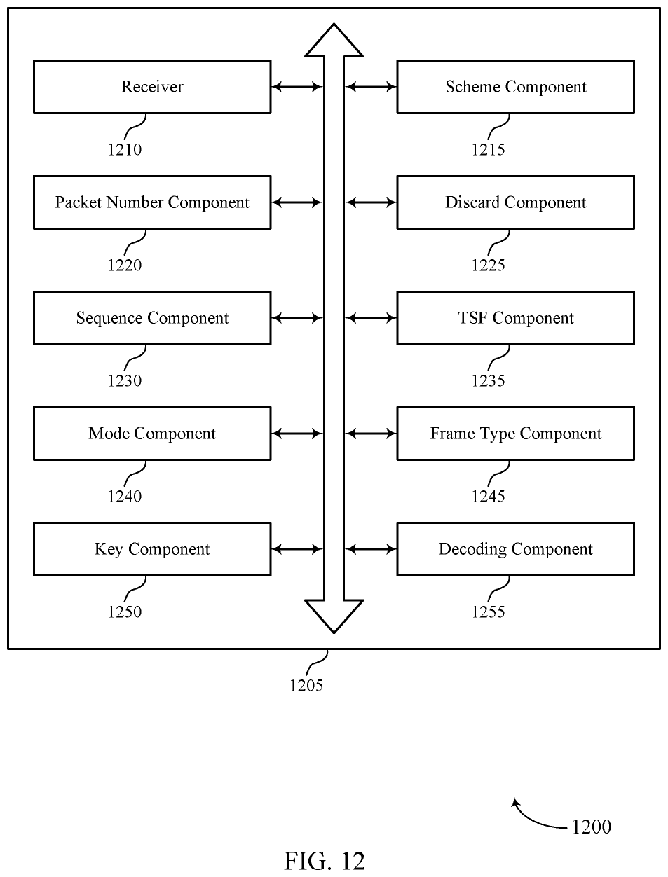

FIG. 12 shows a block diagram 1200 of a communications manager 1205 that supports key and packet number management for WUR frames in accordance with aspects of the present disclosure. The communications manager 1205 may be an example of aspects of a communications manager 1015, a communications manager 1115, or a communications manager 1310 described herein. The communications manager 1205 may include a receiver 1210, a scheme component 1215, a packet number component 1220, a discard component 1225, a sequence component 1230, a TSF component 1235, a mode component 1240, a frame type component 1245, a key component 1250, and a decoding component 1255. Each of these modules may communicate, directly or indirectly, with one another (e.g., via one or more buses).

The receiver 1210 may receive a WUR frame for the STA at a WUR. In some examples, the receiver 1210 may receive, from an AP (e.g., during association with the AP), an indication of the scheme that the STA is to use to construct the packet number. In some examples, the receiver 1210 may receive, in response to the transmitted request, an indication of the scheme that the STA is to use to construct the packet number.

The scheme component 1215 may identify, from among a set of packet number generation schemes, a scheme that the STA is to use to construct a packet number for the WUR frame. In some examples, the scheme component 1215 may transmit a request identifying one of the set of packet number generation schemes. In some examples, the scheme component 1215 may identify the scheme based on the received indication. In some examples, the scheme component 1215 may identify the scheme based on the mode of operation for the WUR. In some examples, the scheme component 1215 may identify a first scheme of the set of packet number generation schemes when the WUR frame is addressed to a set of STAs or a group of STAs. In some examples, the scheme component 1215 may identify a second scheme of the set of packet number generation schemes when the WUR frame is individually addressed to the STA. In some examples, the scheme component 1215 may identify the scheme based on the WUR frame type.

In some examples, the scheme component 1215 may receive an indication of the scheme that the STA is to use to construct the packet number for the WUR frame based on a signaling from an AP. In some examples, the scheme component 1215 may identify that the scheme that the STA is to use to construct the packet number for the WUR frame is common for all STAs associated with the AP. In some examples, the scheme component 1215 may identify that the scheme that the STA is to use to construct the packet number for the WUR frame is individual for each STA associated with the AP. In some cases, the signaling includes an address field of the WUR frame indicating that the WUR frame is broadcast, group-addressed, or individually-addressed. In some cases, the scheme that the STA is to use to construct the packet number for the WUR frame is common for all STAs associated with the AP or individual for each STA associated with the AP.

The packet number component 1220 may generate a packet number for the received WUR frame based on the identified scheme. In some examples, the packet number component 1220 may generate the packet number based on the identified sequence number and a base packet number. In some cases, the base packet number may be locally stored (e.g., by the packet number component 1220). In some examples, the packet number component 1220 may generate the packet number based on the identified partial TSF and a base TSF. In some cases, the base TSF may be locally stored (e.g., by the packet number component 1220). In some examples, the packet number component 1220 may generate the packet number of the WUR frame based on a TSF of the AP. In some examples, the packet number component 1220 may generate the packet number of the WUR frame based on a packet number that does not repeat for a transmitter-receiver couple. In some examples, the packet number component 1220 may generate the packet number of the WUR frame based on the identified partial TSF and the identified clock drift offset.

In some examples, the packet number component 1220 may identify a first time value for receipt of the partial TSF at the STA. In some examples, the packet number component 1220 may initialize a stored base packet number to a value equal to zero. In some examples, the packet number component 1220 may generate, in response to the received indication, the packet number based on the identified sequence number and a base packet number for a transmitter-receiver couple associated with the received WUR frame. In some examples, the packet number component 1220 may receive an indication that an AP associated with the STA maintains a common packet number for all STAs associated with the AP that is valued for all secure WUR frames generated by the AP.

The discard component 1225 may determine whether to discard the WUR frame based on the generated packet number. The frame type component 1245 may receive a protected WUR frame from the AP. In some examples, the frame type component 1245 may decode the protected WUR frame based on the same key or the second key. In some examples, the frame type component 1245 may identify a frame type associated with the WUR frame.

The key component 1250 may determine whether the STA is to use, for communications received from an AP to a wakeup radio, a same key or a second key, the second key different from a first key used by the STA to receive protected communications from the AP to a primary radio of the STA. In some examples, the key component 1250 may determine the second key for the STA to use based on a shared secret between the STA and the AP. In some examples, the key component 1250 may derive the second key from the first key. In some examples, the key component 1250 may add a bit to the first key to generate the second key based on identifying that the wakeup radio is to use the second key.

In some examples, the key component 1250 may apply a function to the first key to generate the second key based on identifying that the wakeup radio is to use the second key, the applied function known to both the AP and the STA. In some examples, the key component 1250 may receive, from the AP, an indication that the STA is to use one of the same key or the second key to receive protected communications using the wakeup radio. In some examples, the key component 1250 may transmit, to the AP, an indication of a preference to use the same key or the second key, where the determination to use the same key or the second key is based on the preference.

In some examples, the key component 1250 may receive, in one or more messages of a four-way handshake procedure with the AP, an indication that the STA is to use one of the same key or the second key to receive protected communications using the wakeup radio. In some cases, the second key is different from the first key for the primary radio by at least one bit, the at least one bit indicating that the second key is for the wakeup radio. In some cases, the first key includes an individual key for the STA, and the second key includes a group key for a group of STAs that includes the STA. In some cases, the first key includes a PTK, the same key includes the PTK, and the second key includes an IGTK key. In some cases, the first key includes group key for a group of STAs that includes the STA, and the second key includes an individual key for the STA. In some cases, the first key includes an IGTK key, the same key includes the IGTK, and the second key includes a PTK. In some cases, the first key may be an individual key for the STA to be used for communications via the primary radio, and the second key may be an individual key for the STA to be used for communications via the wakeup radio (e.g., where the first key comprises a first PTK and the second key comprises a second PTK). In some cases, the first key may be a group key for the STA to be used for communications via the primary radio, and the second key may be a group key for the STA to be used for communications via the wakeup radio (e.g., where the first key comprises a first IGTK, and the second key comprises a second IGTK).

The sequence component 1230 may identify a sequence number in the received WUR frame. In some cases, the sequence number is equal to twelve least significant bits of the packet number of the received WUR frame, and the base packet number includes at least a portion of a base packet number stored at the STA.

The TSF component 1235 may identify a partial TSF in the received WUR frame. In some examples, the TSF component 1235 may initialize a stored base packet number to a value equal to at least a portion of a local TSF timer. In some examples, the TSF component 1235 may identify a partial TSF in the received WUR frame. In some examples, the TSF component 1235 may identify a clock drift offset between a local TSF timer and a TSF timer of a wireless device that transmitted the WUR frame. In some examples, the TSF component 1235 may identify a second time value for a second partial TSF previously received at the STA. In some examples, the TSF component 1235 may determine the clock drift offset based on the identified first time value, the identified second time value, and an estimated clock drift for the local TSF timer.

In some examples, the TSF component 1235 may receive a first TSF value from an access point in a first WUR frame. In some examples, the TSF component 1235 may receive a second TSF value from the access point in a second WUR frame. In some examples, the TSF component 1235 may estimate a clock drift based on comparing the first TSF value to the local TSF timer and the second TSF value to the local TSF timer. In some examples, the TSF component 1235 may identify the clock drift offset based on the estimated clock drift. In some examples, the TSF component 1235 may receive an indication that an AP associated with the STA maintains separate counters for each transmitter-receiver couple. In some cases, the stored packet number is obtained from 6 bytes of the local TSF timer, the 6 bytes of the local TSF timer being 48 bits out of 64 bits of the local TSF timer.

The mode component 1240 may identify a mode of operation for the WUR of the STA. In some examples, the mode component 1240 may establish a broadcast link with an access point. The decoding component 1255 may decode the protected WUR frame using a group key, where the protected WUR frame is group addressed. The decoding component 1255 may decode the protected WUR frame using an individual key, where the protected WUR frame is individually addressed.

FIG. 13 shows a diagram of a system 1300 including a device 1305 that supports key and packet number management for WUR frames in accordance with aspects of the present disclosure. The device 1305 may be an example of or include the components of device 1005, device 1105, or a STA (e.g., STA 115) as described herein. The device 1305 may include components for bi-directional voice and data communications including components for transmitting and receiving communications, including a communications manager 1310, an I/O controller 1315, a transceiver 1320, an antenna 1325, memory 1330, and a processor 1340. These components may be in electronic communication via one or more buses (e.g., bus 1345).

The communications manager 1310 may receive a WUR frame for the STA at a WUR, identify, from among a set of packet number generation schemes, a scheme that the STA is to use to construct a packet number for the WUR frame, generate a packet number for the received WUR frame based on the identified scheme, and determine whether to discard the WUR frame based on the generated packet number. The communications manager 1310 may also determine whether the STA is to use, for communications received from an AP to a wakeup radio, a same key or a second key, the second key different from a first key used by the STA to receive protected communications from the AP to a primary radio of the STA, receive a protected WUR frame from the AP, and decode the protected WUR frame based on the same key or the second key.

I/O controller 1315 may manage input and output signals for device 1305. I/O controller 1315 may also manage peripherals not integrated into device 1305. In some cases, I/O controller 1315 may represent a physical connection or port to an external peripheral. In some cases, I/O controller 1315 may utilize an operating system such as i0S®, ANDROID®, MS-DOS®, MS-WINDOWS®, OS/2®, UNIX®, LINUX®, or another known operating system. In other cases, I/O controller 1315 may represent or interact with a modem, a keyboard, a mouse, a touchscreen, or a similar device. In some cases, I/O controller 1315 may be implemented as part of a processor. In some cases, a user may interact with device 1305 via I/O controller 1315 or via hardware components controlled by I/O controller 1315.

Transceiver 1320 may communicate bi-directionally, via one or more antennas, wired, or wireless links as described above. For example, the transceiver 1320 may represent a wireless transceiver and may communicate bi-directionally with another wireless transceiver. The transceiver 1320 may also include a modem to modulate the packets and provide the modulated packets to the antennas for transmission, and to demodulate packets received from the antennas. In some cases, the wireless device may include a single antenna 1325. However, in some cases the device may have more than one antenna 1325, which may be capable of concurrently transmitting or receiving multiple wireless transmissions.

Transceiver 1320 may include a primary radio 1350 and a wakeup radio 1355. The transceiver 1320 may include separate chains (e.g., receive and transmit chains) and antennas for each of the primary radio 1350 and the wakeup radio 1355. The primary radio 1350 may be used during an active mode (e.g., full power modes), for high-data throughput applications, etc. The wakeup radio 1355 may be used during low-power modes, for low-throughout applications, etc. In some examples, the device 1305 may listen using the wakeup radio 1355 for a WUR frame. For example, the device 1305 may receive a preamble having a first frequency band (e.g., wideband, such as on a 20 MHz channel) and a wakeup signal (e.g., a WUR signal) having a second frequency band (e.g., narrowband, such as a 4-5 MHz within the 20 MHz channel). Further, the wakeup radio 1355 may share a same medium (e.g., frequency spectrum targeted for reception) as the primary radio 1350. However, transmissions intended for the wakeup radio 1355 may be associated with lower data rates.

Memory 1330 may include RAM and ROM. The memory 1330 may store computer-readable, computer-executable code or software 1335 including instructions that, when executed, cause the processor to perform various functions described herein. In some cases, the memory 1330 may contain, among other things, a BIOS which may control basic hardware or software operation such as the interaction with peripheral components or devices.

Software 1335 may include code to implement aspects of the present disclosure, including code to support key and packet number management for WUR frames. Software 1335 can be stored in a non-transitory computer-readable medium such as system memory or other memory. In some cases, the software 1335 may not be directly executable by the processor but may cause a computer (e.g., when compiled and executed) to perform functions described herein.

Processor 1340 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1340 may be configured to operate a memory array using a memory controller. In other cases, a memory controller may be integrated into processor 1340. Processor 1340 may be configured to execute computer-readable instructions stored in a memory to perform various functions (e.g., functions or tasks supporting key and packet number management for WUR frames).

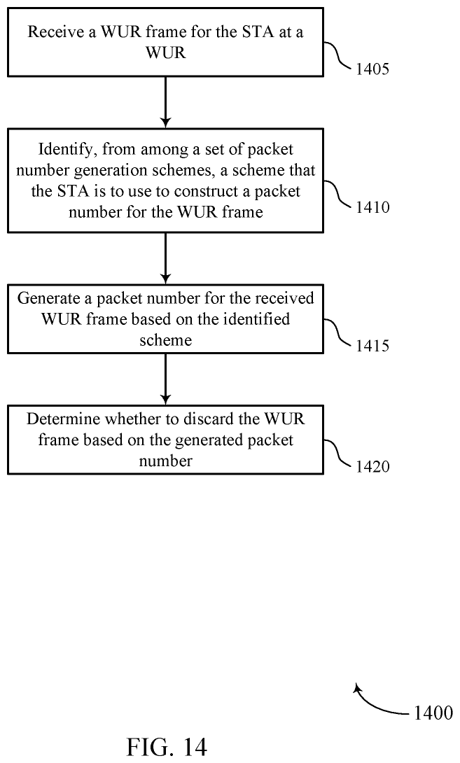

FIG. 14 shows a flowchart illustrating a method 1400 that supports key and packet number management for WUR frames in accordance with aspects of the present disclosure. The operations of method 1400 may be implemented by a STA or its components as described herein. For example, the operations of method 1400 may be performed by a communications manager as described with reference to FIGS. 10 through 13. In some examples, a STA may execute a set of instructions to control the functional elements of the STA to perform the functions described below. Additionally or alternatively, a STA may perform aspects of the functions described below using special-purpose hardware.

At 1405, the STA may receive a WUR frame for the STA at a WUR. The operations of 1405 may be performed according to the methods described herein. In some examples, aspects of the operations of 1405 may be performed by a receiver as described with reference to FIGS. 10 through 13.

At 1410, the STA may identify, from among a set of packet number generation schemes, a scheme that the STA is to use to construct a packet number for the WUR frame. The operations of 1410 may be performed according to the methods described herein. In some examples, aspects of the operations of 1410 may be performed by a scheme component as described with reference to FIGS. 10 through 13.

At 1415, the STA may generate a packet number for the received WUR frame based on the identified scheme. The operations of 1415 may be performed according to the methods described herein. In some examples, aspects of the operations of 1415 may be performed by a packet number component as described with reference to FIGS. 10 through 13.

At 1420, the STA may determine whether to discard the WUR frame based on the generated packet number. The operations of 1420 may be performed according to the methods described herein. In some examples, aspects of the operations of 1420 may be performed by a discard component as described with reference to FIGS. 10 through 13.

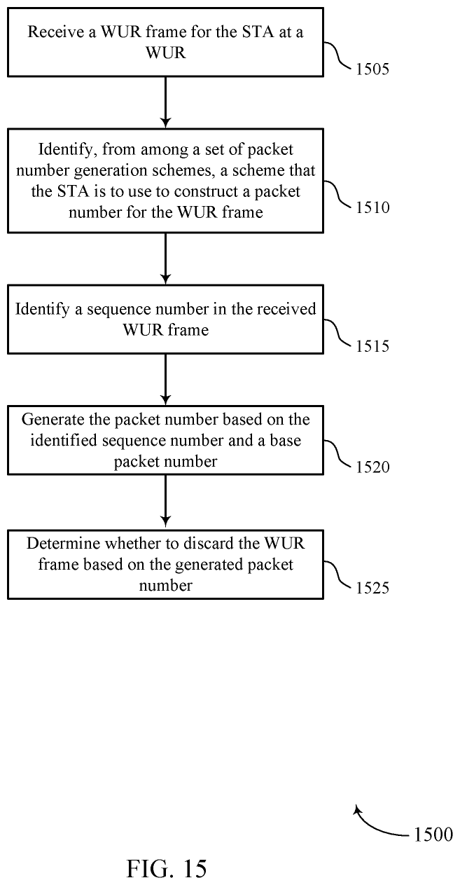

FIG. 15 shows a flowchart illustrating a method 1500 that supports key and packet number management for WUR frames in accordance with aspects of the present disclosure. The operations of method 1500 may be implemented by a STA or its components as described herein. For example, the operations of method 1500 may be performed by a communications manager as described with reference to FIGS. 10 through 13. In some examples, a STA may execute a set of instructions to control the functional elements of the STA to perform the functions described below. Additionally or alternatively, a STA may perform aspects of the functions described below using special-purpose hardware.

At 1505, the STA may receive a WUR frame for the STA at a WUR. The operations of 1505 may be performed according to the methods described herein. In some examples, aspects of the operations of 1505 may be performed by a receiver as described with reference to FIGS. 10 through 13.

At 1510, the STA may identify, from among a set of packet number generation schemes, a scheme that the STA is to use to construct a packet number for the WUR frame. The operations of 1510 may be performed according to the methods described herein. In some examples, aspects of the operations of 1510 may be performed by a scheme component as described with reference to FIGS. 10 through 13.

At 1515, the STA may identify a sequence number in the received WUR frame. The operations of 1515 may be performed according to the methods described herein. In some examples, aspects of the operations of 1515 may be performed by a sequence component as described with reference to FIGS. 10 through 13.

At 1520, the STA may generate the packet number based on the identified sequence number and a base packet number. The operations of 1520 may be performed according to the methods described herein. In some examples, aspects of the operations of 1520 may be performed by a packet number component as described with reference to FIGS. 10 through 13.

At 1525, the STA may determine whether to discard the WUR frame based on the generated packet number. The operations of 1525 may be performed according to the methods described herein. In some examples, aspects of the operations of 1525 may be performed by a discard component as described with reference to FIGS. 10 through 13.

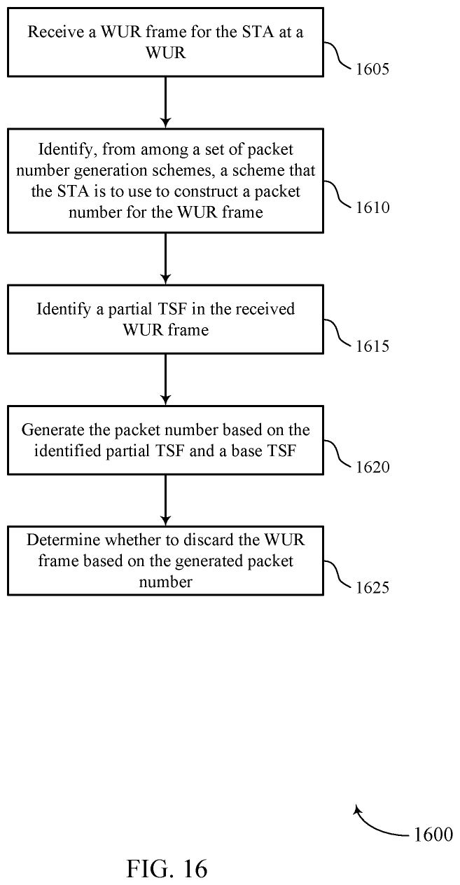

FIG. 16 shows a flowchart illustrating a method 1600 that supports key and packet number management for WUR frames in accordance with aspects of the present disclosure. The operations of method 1600 may be implemented by a STA or its components as described herein. For example, the operations of method 1600 may be performed by a communications manager as described with reference to FIGS. 10 through 13. In some examples, a STA may execute a set of instructions to control the functional elements of the STA to perform the functions described below. Additionally or alternatively, a STA may perform aspects of the functions described below using special-purpose hardware.

At 1605, the STA may receive a WUR frame for the STA at a WUR. The operations of 1605 may be performed according to the methods described herein. In some examples, aspects of the operations of 1605 may be performed by a receiver as described with reference to FIGS. 10 through 13.

At 1610, the STA may identify, from among a set of packet number generation schemes, a scheme that the STA is to use to construct a packet number for the WUR frame. The operations of 1610 may be performed according to the methods described herein. In some examples, aspects of the operations of 1610 may be performed by a scheme component as described with reference to FIGS. 10 through 13.

At 1615, the STA may identify a partial TSF in the received WUR frame. The operations of 1615 may be performed according to the methods described herein. In some examples, aspects of the operations of 1615 may be performed by a TSF component as described with reference to FIGS. 10 through 13.

At 1620, the STA may generate the packet number based on the identified partial TSF and a base TSF. The operations of 1620 may be performed according to the methods described herein. In some examples, aspects of the operations of 1620 may be performed by a packet number component as described with reference to FIGS. 10 through 13.

At 1625, the STA may determine whether to discard the WUR frame based on the generated packet number. The operations of 1625 may be performed according to the methods described herein. In some examples, aspects of the operations of 1625 may be performed by a discard component as described with reference to FIGS. 10 through 13.

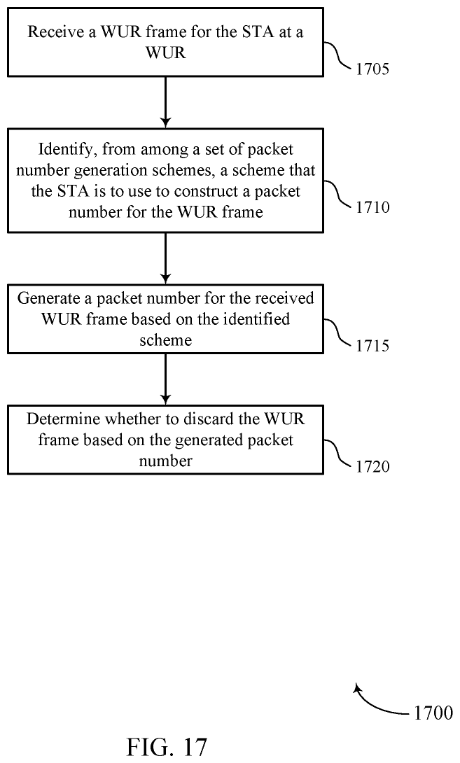

FIG. 17 shows a flowchart illustrating a method 1700 that supports key and packet number management for WUR frames in accordance with aspects of the present disclosure. The operations of method 1700 may be implemented by a STA or its components as described herein. For example, the operations of method 1700 may be performed by a communications manager as described with reference to FIGS. 10 through 13. In some examples, a STA may execute a set of instructions to control the functional elements of the STA to perform the functions described below. Additionally or alternatively, a STA may perform aspects of the functions described below using special-purpose hardware.

At 1705, the STA may receive a WUR frame for the STA at a WUR. The operations of 1705 may be performed according to the methods described herein. In some examples, aspects of the operations of 1705 may be performed by a receiver as described with reference to FIGS. 10 through 13.

At 1710, the STA may identify, from among a set of packet number generation schemes, a scheme that the STA is to use to construct a packet number for the WUR frame. The operations of 1710 may be performed according to the methods described herein. In some examples, aspects of the operations of 1710 may be performed by a scheme component as described with reference to FIGS. 10 through 13.

At 1715, the STA may generate a packet number for the received WUR frame based on the identified scheme. The operations of 1715 may be performed according to the methods described herein. In some examples, aspects of the operations of 1715 may be performed by a packet number component as described with reference to FIGS. 10 through 13.

At 1720, the STA may determine whether to discard the WUR frame based on the generated packet number. The operations of 1720 may be performed according to the methods described herein. In some examples, aspects of the operations of 1720 may be performed by a discard component as described with reference to FIGS. 10 through 13.

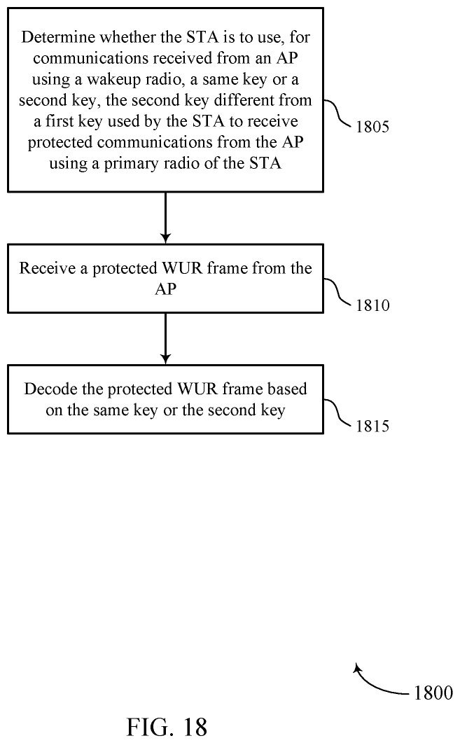

FIG. 18 shows a flowchart illustrating a method 1800 that supports key and packet number management for WUR frames in accordance with aspects of the present disclosure. The operations of method 1800 may be implemented by a STA or its components as described herein. For example, the operations of method 1800 may be performed by a communications manager as described with reference to FIGS. 10 through 13. In some examples, a STA may execute a set of instructions to control the functional elements of the STA to perform the functions described below. Additionally or alternatively, a STA may perform aspects of the functions described below using special-purpose hardware.

At 1805, the STA may determine whether the STA is to use, for communications received from an AP to a wakeup radio, a same key or a second key, the second key different from a first key used by the STA to receive protected communications from the AP to a primary radio of the STA. The operations of 1805 may be performed according to the methods described herein. In some examples, aspects of the operations of 1805 may be performed by a key component as described with reference to FIGS. 10 through 13.

At 1810, the STA may receive a protected WUR frame from the AP. The operations of 1810 may be performed according to the methods described herein. In some examples, aspects of the operations of 1810 may be performed by a frame type component as described with reference to FIGS. 10 through 13.

At 1815, the STA may decode the protected WUR frame based on the same key or the second key. The operations of 1815 may be performed according to the methods described herein. In some examples, aspects of the operations of 1815 may be performed by a frame type component as described with reference to FIGS. 10 through 13.

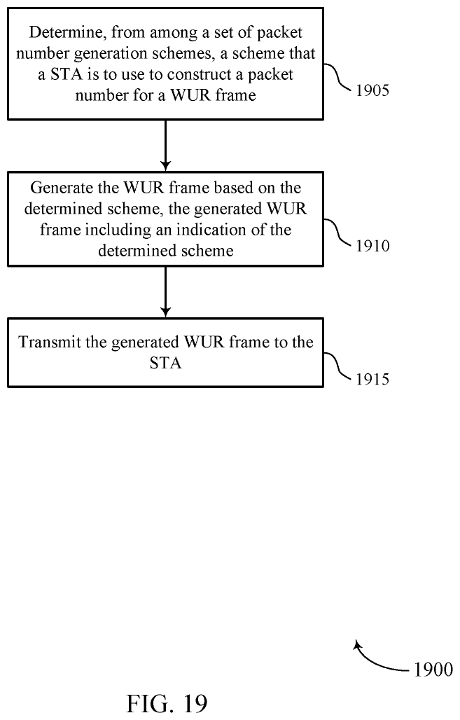

FIG. 19 shows a flowchart illustrating a method 1900 that supports key and packet number management for WUR frames in accordance with aspects of the present disclosure. The operations of method 1900 may be implemented by an AP or its components as described herein. For example, the operations of method 1900 may be performed by a communications manager as described with reference to FIGS. 6 through 9. In some examples, an AP may execute a set of instructions to control the functional elements of the AP to perform the functions described below. Additionally or alternatively, an AP may perform aspects of the functions described below using special-purpose hardware.

At 1905, the AP may determine, from among a set of packet number generation schemes, a scheme that a STA is to use to construct a packet number for a WUR frame. The operations of 1905 may be performed according to the methods described herein. In some examples, aspects of the operations of 1905 may be performed by a scheme component as described with reference to FIGS. 6 through 9.

At 1910, the AP may generate the WUR frame based on the determined scheme, the generated WUR frame including an indication of the determined scheme. The operations of 1910 may be performed according to the methods described herein. In some examples, aspects of the operations of 1910 may be performed by a frame generation component as described with reference to FIGS. 6 through 9.

At 1915, the AP may transmit the generated WUR frame to the STA. The operations of 1915 may be performed according to the methods described herein. In some examples, aspects of the operations of 1915 may be performed by a transmitter as described with reference to FIGS. 6 through 9.

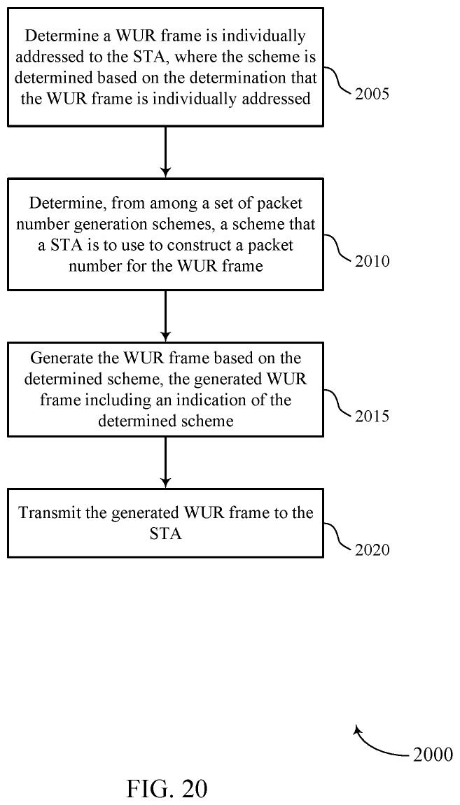

FIG. 20 shows a flowchart illustrating a method 2000 that supports key and packet number management for WUR frames in accordance with aspects of the present disclosure. The operations of method 2000 may be implemented by an AP or its components as described herein. For example, the operations of method 2000 may be performed by a communications manager as described with reference to FIGS. 6 through 9. In some examples, an AP may execute a set of instructions to control the functional elements of the AP to perform the functions described below. Additionally or alternatively, an AP may perform aspects of the functions described below using special-purpose hardware.

At 2005, the AP may determine a WUR frame is individually addressed to the STA, where the scheme is determined based on the determination that the WUR frame is individually addressed. The operations of 2005 may be performed according to the methods described herein. In some examples, aspects of the operations of 2005 may be performed by a frame type component as described with reference to FIGS. 6 through 9.

At 2010, the AP may determine, from among a set of packet number generation schemes, a scheme that a STA is to use to construct a packet number for the WUR frame. The operations of 2010 may be performed according to the methods described herein. In some examples, aspects of the operations of 2010 may be performed by a scheme component as described with reference to FIGS. 6 through 9.

At 2015, the AP may generate the WUR frame based on the determined scheme, the generated WUR frame including an indication of the determined scheme (e.g., where the WUR frame is generated based at least in part on the determined scheme and a sequence number of the WUR frame). The operations of 2015 may be performed according to the methods described herein. In some examples, aspects of the operations of 2015 may be performed by a frame generation component as described with reference to FIGS. 6 through 9.

At 2020, the AP may transmit the generated WUR frame to the STA. The operations of 2020 may be performed according to the methods described herein. In some examples, aspects of the operations of 2020 may be performed by a transmitter as described with reference to FIGS. 6 through 9.

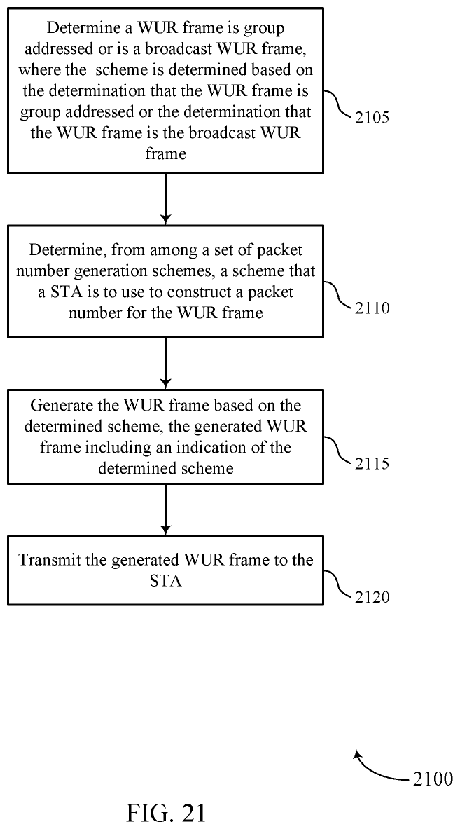

FIG. 21 shows a flowchart illustrating a method 2100 that supports key and packet number management for WUR frames in accordance with aspects of the present disclosure. The operations of method 2100 may be implemented by an AP or its components as described herein. For example, the operations of method 2100 may be performed by a communications manager as described with reference to FIGS. 6 through 9. In some examples, an AP may execute a set of instructions to control the functional elements of the AP to perform the functions described below. Additionally or alternatively, an AP may perform aspects of the functions described below using special-purpose hardware.

At 2105, the AP may determine a WUR frame is group addressed or is a broadcast WUR frame, where the scheme is determined based on the determination that the WUR frame is group addressed or the determination that the WUR frame is the broadcast WUR frame. The operations of 2105 may be performed according to the methods described herein. In some examples, aspects of the operations of 2105 may be performed by a frame type component as described with reference to FIGS. 6 through 9.

At 2110, the AP may determine, from among a set of packet number generation schemes, a scheme that a STA is to use to construct a packet number for the WUR frame. The operations of 2110 may be performed according to the methods described herein. In some examples, aspects of the operations of 2110 may be performed by a scheme component as described with reference to FIGS. 6 through 9.

At 2115, the AP may generate the WUR frame based on the determined scheme, the generated WUR frame including an indication of the determined scheme (e.g., where the WUR frame is generated based at least in part on the determined scheme and a partial TSF of the generated WUR frame). The operations of 2115 may be performed according to the methods described herein. In some examples, aspects of the operations of 2115 may be performed by a frame generation component as described with reference to FIGS. 6 through 9.

At 2120, the AP may transmit the generated WUR frame to the STA. The operations of 2120 may be performed according to the methods described herein. In some examples, aspects of the operations of 2120 may be performed by a transmitter as described with reference to FIGS. 6 through 9.

It should be noted that the methods described herein describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLANs 100 and 200 of FIGS. 1 and —may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. An apparatus for wireless communications, comprising:
a first interface;
a second interface; and
a wireless modem configured to:
obtain, over the first interface, a wakeup radio (WUR) frame received at a WUR of a station (STA);
identify, from among a plurality of packet number generation schemes, a scheme to use to construct a packet number for the WUR frame;
generate a packet number for the obtained WUR frame based at least in part on the identified scheme; and
determine whether to discard the WUR frame based at least in part on the generated packet number.

2. The apparatus of claim 1, wherein the wireless modem configured to generate the packet number for the obtained WUR frame comprises the wireless modem configured to:
identify a sequence number in the obtained WUR frame; and
generate the packet number based at least in part on the identified sequence number and a base packet number.

3. (canceled)

4. The apparatus of claim 1, wherein the wireless modem configured to generate the packet number for the obtained WUR frame comprises the wireless modem configured to:
identify a partial timing synchronization function (TSF) in the obtained WUR frame; and
generate the packet number based at least in part on the identified partial TSF and a base TSF.

5-8. (canceled)

9. The apparatus of claim 1, wherein the wireless modem configured to identify the scheme comprises the wireless modem configured to:
identify a mode of operation for the WUR of the STA; and
identify the scheme based at least in part on the mode of operation for the WUR.

10. The apparatus of claim 1, wherein the wireless modem configured to identify the scheme comprises the wireless modem configured to:
identify a first scheme of the plurality of packet number generation schemes when the WUR frame is addressed to a plurality of STAs or a group of STAs; and
identify a second scheme of the plurality of packet number generation schemes when the WUR frame is individually addressed to the STA.

11. (canceled)

12. The apparatus of claim 1, wherein the wireless modem is further configured to:
obtain, over the first interface, an indication of the scheme that the apparatus is to use to construct the packet number for the WUR frame based at least in part on a signaling from an access point (AP).

13. The apparatus of claim 12, wherein the signaling comprises an address field of the WUR frame indicating that the WUR frame is broadcast, group-addressed, or individually-addressed.

14. The apparatus of claim 1, wherein the scheme that the wireless modem is to use to construct the packet number for the WUR frame is common for all STAs associated with the AP or individual for each STA associated with the AP.

15. The apparatus of claim 14, wherein the wireless modem configured to generate the packet number for the obtained WUR frame comprises the wireless modem configured to:
identify that the scheme that the wireless modem is to use to construct the packet number for the WUR frame is common for all STAs associated with the AP; and
generate the packet number of the WUR frame based at least in part on a timing synchronization function (TSF) of the AP.

16. The apparatus of claim 14, wherein the wireless modem configured to generate the packet number for the obtained WUR frame comprises the wireless modem configured to:
identify that the scheme that the wireless modem is to use to construct the packet number for the WUR frame is individual for each STA associated with the AP; and
generate the packet number of the WUR frame based at least in part on a packet number that does not repeat for a transmitter-receiver couple.

17. The apparatus of claim 1, wherein the wireless modem is further configured to:
provide, over the second interface, an indication for the STA to establish a broadcast link with an access point; and
initialize a stored base packet number to a value equal to at least a portion of a local timing synchronization function (TSF) timer.

18. (canceled)

19. The apparatus of claim 1, wherein the wireless modem configured to generate the packet number for the obtained WUR frame comprises the wireless modem configured to:
identify a partial timing synchronization function (TSF) in the obtained WUR frame;
identify a clock drift offset between a local TSF timer and a TSF timer of a wireless device that transmitted the WUR frame; and
generate the packet number of the WUR frame based at least in part on the identified partial TSF and the identified clock drift offset.

20. The apparatus of claim 19, wherein the wireless modem configured to identify the clock drift offset comprises the wireless modem configured to:
identify a first time value for receipt of the partial TSF at the STA;
identify a second time value for a second partial TSF previously received at the STA; and
determine the clock drift offset based at least in part on the identified first time value, the identified second time value, and an estimated clock drift for the local TSF timer.

21. The apparatus of claim 19, wherein the wireless modem configured to identify the clock drift offset comprises the wireless modem configured to:
obtain, over the first interface, a first TSF value received from an access point in a first WUR frame;
obtain, over the first interface, a second TSF value received from the access point in a second WUR frame;
estimate a clock drift based at least in part on comparing the first TSF value to the local TSF timer and the second TSF value to the local TSF timer; and
identify the clock drift offset based at least in part on the estimated clock drift.

22. The apparatus of claim 1, wherein the wireless modem is further configured to:
initialize a stored base packet number to a value equal to zero.

23. The apparatus of claim 1, wherein the wireless modem is further configured to:
obtain, over the first interface, an indication that an access point (AP) associated with the STA maintains separate counters for each transmitter-receiver couple;
identify a sequence number in the obtained WUR frame; and
generate, in response to the obtained indication, the packet number based at least in part on the identified sequence number and a base packet number for a transmitter-receiver couple associated with the obtained WUR frame.

24. The apparatus of claim 23, wherein the sequence number is equal to twelve least significant bits of the packet number of the obtained WUR frame, and the base packet number comprises at least a portion of a base packet number stored at the wireless modem.

25. The apparatus of claim 1, wherein the modem is further configured to:
obtain, over the first interface, an indication that an access point (AP) associated with the STA maintains a common packet number for all STAs associated with the AP that is valued for all secure WUR frames generated by the AP.

26. An apparatus for wireless communications, comprising:
a first interface;
a second interface; and
a wireless modem configured to:
determine whether the wireless modem is to use, for communications received from an access point (AP) to a wakeup radio of a station (STA), a same key or a second key, the second key different from a first key used by the wireless modem for protected communications received from the AP to a primary radio of the STA;
obtain, over the first interface, a protected wakeup radio (WUR) frame received from the AP; and
decode the protected WUR frame based at least in part on the same key or the second key.

27. The apparatus of claim 26, wherein the second key is different from the first key for the primary radio by at least one bit, the at least one bit indicating that the second key is for the wakeup radio.

28. The apparatus of claim 26, wherein the wireless modem is further configured to:
determine the second key for the wireless modem to use based at least in part on a shared secret between the STA and the AP.

29. The apparatus of claim 26, wherein the wireless modem is further configured to:
derive the second key from the first key.

30. The apparatus of claim 29, wherein the wireless modem configured to determine the second key comprises the wireless modem configured to:
add a bit to the first key to generate the second key based at least in part on identifying that the wakeup radio is to use the second key.

31. The apparatus of claim 29, wherein the wireless modem configured to determine the second key comprises the wireless modem configured to:
apply a function to the first key to generate the second key based at least in part on identifying that the wireless modem is to use the second key, the applied function known to both the AP and the wireless modem.

32. The apparatus of claim 26, wherein the wireless modem is further configured to:
obtain, over the first interface, an indication received from the AP that the STA is to use one of the same key or the second key to receive protected communications using the wakeup radio.

33. The apparatus of claim 26, wherein the wireless modem is further configured to:
provide, over the second interface for the AP to transmit, an indication of a preference to use the same key or the second key, wherein the determination to use the same key or the second key is based at least in part on the preference.

34. The apparatus of claim 26, wherein the wireless modem configured to decode the protected WUR frame comprises the wireless modem configured to:
decode the protected WUR frame using a group key, wherein the protected WUR frame is group addressed or broadcast addressed.

35. The apparatus of claim 26, wherein the wireless modem configured to decode the protected WUR frame comprises the wireless modem configured to:
decode the protected WUR frame using an individual key, wherein the protected WUR frame is individually addressed.

36. The apparatus of claim 26, wherein the first key comprises an individual key for the STA to be used for communications via the primary radio, and the second key comprises an individual key for the STA to be used for communications via the wakeup radio.

37. The apparatus of claim 36, wherein the first key comprises a first pairwise transient key (PTK) and the second key comprises a second PTK.

38. The apparatus of claim 26, wherein the first key comprises a group key for the STA to be used for communications via the primary radio, and the second key comprises a group key for the STA to be used for communications via the wakeup radio.

39. The apparatus of claim 38, wherein the first key comprises a first integrity group temporal key (IGTK), and the second key comprises a second IGTK.

40. The apparatus of claim 26, wherein the wireless modem is further configured to:
obtain, over the first interface in one or more messages of a four-way handshake procedure with the AP, an indication received from the AP that the STA is to use one of the same key or the second key to receive protected communications using the wakeup radio.

41. An apparatus for wireless communications, comprising:
a first interface;
a second interface; and
a wireless modem configured to:
determine, from among a plurality of packet number generation schemes, a scheme that a station (STA) is to use to construct a packet number for a wakeup radio (WUR) frame;
generate the WUR frame based at least in part on the determined scheme, the generated WUR frame comprising an indication of the determined scheme; and
provide, over the second interface, the generated WUR frame to be transmitted to the STA.

42. The apparatus of claim 41, wherein the wireless modem is further configured to:
determine the WUR frame is individually addressed to the STA, wherein the scheme is determined based at least in part on the determination that the WUR frame is individually addressed.

43. The apparatus of claim 42, wherein the WUR frame is generated based at least in part on the determined scheme and a sequence number of the WUR frame.

44. The apparatus of claim 41, wherein the wireless modem is further configured to:
determine the WUR frame is group addressed or is a broadcast WUR frame, wherein the scheme is determined based at least in part on the determination that the WUR frame is group addressed or the determination that the WUR frame is the broadcast WUR frame.

45. The apparatus of claim 44, wherein the WUR frame is generated based at least in part on the determined scheme and a partial timing synchronization function (TSF) of the generated WUR frame.

46. The apparatus of claim 41, wherein the wireless modem is further configured to:
determine the packet number based at least in part on the determined scheme, wherein the WUR frame is generated based at least in part on the determined packet number.

47. The apparatus of claim 41, wherein the wireless modem is further configured to:
determine a first scheme from among the plurality of packet number generation schemes when the WUR frame is to be addressed to a plurality of STAs or a group of STAs; and
determine a second scheme from among the plurality of packet number generation schemes when the WUR frame is to be individually addressed to the STA.

48. The apparatus of claim 41, wherein the wireless modem configured to generate the WUR frame comprises the wireless modem configured to:
identify a sequence number based at least in part on the determined scheme; and
generate the WUR frame based at least in part on the identified sequence number and a base packet number.

49. The apparatus of claim 41, wherein the wireless modem configured to generate the WUR frame comprises the wireless modem configured to:
identify a partial timing synchronization function (TSF) based at least in part on the determined scheme; and
generate the WUR frame based at least in part on the identified partial TSF and a base TSF.

50. The apparatus of claim 41, wherein the wireless modem configured to determine the scheme for the STA comprises the wireless modem configured to:
identify a mode of operation for a WUR of the STA; and
determine the scheme that the wireless modem is to use to construct the packet number for the WUR frame based at least in part on the identified mode of operation for the WUR.

51-59. (canceled)

60. A method for wireless communications at a station (STA), comprising:
receiving a wakeup radio (WUR) frame for the STA at a WUR;
identifying, from among a plurality of packet number generation schemes, a scheme that the STA is to use to construct a packet number for the WUR frame;
generating a packet number for the received WUR frame based at least in part on the identified scheme; and
determining whether to discard the WUR frame based at least in part on the generated packet number.

61-227. (canceled)
